(19) United States
(12) Patent Application Publication
(10) Pub. No.: US 2013/0298068 A1
(43) Pub. Date: Nov. 7, 2013

(54) CONTENTS DISPLAY METHOD AND MOBILE TERMINAL IMPLEMENTING THE SAME

(71) Applicant: SAMSUNG ELECTRONICS CO., LTD., (unknown)

(72) Inventors: Sanghyup LEE, Suwon-si (KR); Shinjun LEE, Yongin-si (KR)

(21) Appl. No.: 13/909,899

(22) Filed: Jun. 4, 2013

Related U.S. Application Data
(63) Continuation-in-part of application No. 13/739,777, filed on Jan. 11, 2013.

(30) Foreign Application Priority Data
Jan. 31, 2012 (KR) 10-2012-0010106
Feb. 29, 2012 (KR) 10-2012-0021310
Jan. 29, 2013 (KR) 10-2013-0009788

(51) Int. Cl. G06F 3/0483

(52) U.S. Cl. CPC G06F 3/0483
USPC 715/776

(57) ABSTRACT

A method and a mobile terminal for displaying contents are provided. The method of displaying contents for pages of a mobile terminal including a display unit in which a touch panel is installed, includes: displaying a page; detecting movement of a touch input device with respect to the displayed page; and displaying the page so that the page is convexly deformed and skipped in response to the movement of the touch input device.

### PRIORITY

This application is a continuation-in-part of U.S. patent application Ser. No. 13/739,777 filed Jan. 11, 2013 in the U.S. Patent and Trademark Office, which claims priority from Korean Patent Application No. 10-2012-0010106 filed Jan. 31, 2012, and Korean Patent Application No. 10-2012-0021310 filed Feb. 29, 2012, and claims priority from Korean Patent Application No. 10-2013-0009788 filed Jan. 29, 2013 in the Korean Intellectual Property Office, the entire disclosures of which are hereby incorporated by reference in their entirety.

### BACKGROUND

1. Field

Methods and apparatuses consistent with exemplary embodiments of the present disclosure relate to a contents display method and a mobile terminal implementing the same.

2. Description of the Related Art

A mobile terminal provides various contents. The contents may be displayed for each of a plurality of pages. However, a contents display method and an apparatus thereof in the related art do not provide the feeling of operating pages on the mobile terminal which is similar to the feeling of operating an actual paper book for a user. According to a contents display method and an apparatus thereof of the related art, if a user provides input information (e.g., a push) associated with a page skip, for example, a next page button is detected, and a currently displayed page is replaced with a next page. Such a replacement scheme does not actually skip the currently displayed page but simply browses to a next web page. Meanwhile, a recently developed mobile terminal may include a touch screen. The mobile terminal detects and skips pages in response to the detected gesture. When the user skips the pages, the mobile terminal according to the related art provides an animation which gradually folds a current page (that is, a front surface of the page) and shows a next page (that is, a back surface of the page) regardless of a touched point or a direction of drag.

### SUMMARY

One or more exemplary embodiments provide a contents display method capable of achieving a realistic feeling for a user when the user operates a screen on which a page is displayed by a touch input device (e.g., finger or pen), and an apparatus thereof.

One or more exemplary embodiments also provide a contents display method in which an animation of pages being skipped provides a realistic feeling, and an apparatus thereof.

In accordance with an aspect of an exemplary embodiment, there is provided a method of displaying contents of pages displayed by a mobile terminal including a display unit in which a touch panel is installed, the method including: displaying a page; detecting movement of a touch input device with respect to the displayed page; and displaying the page so that the page is convexly deformed and skipped in response to the movement of the touch input device.

In accordance with an aspect of another exemplary embodiment, there is provided a mobile terminal including: a display unit in which a touch panel is installed and configured to display contents for each of a plurality of pages; a memory configured to store the pages; and a controller configured to control the display unit such that one of the pages is displayed, detect movement of a touch input device with respect to the displayed page, and control the display unit such that the page is displayed as convexly deformed and skipped in response to the movement of the touch input device.

In accordance with an aspect of another exemplary embodiment, there is provided a method to display pages including: displaying a page on a device including a touch input unit, generating a page mesh corresponding to the displayed page, the page mesh including a plurality of nodes having respective weights, detecting movement of a touch input device with respect to the displayed page, using the touch input unit, and changing an appearance of the page according to the detected movement and the page mesh.

### BRIEF DESCRIPTION OF THE DRAWINGS

The above and/or other aspects will be more apparent from the following detailed description of exemplary embodiments in conjunction with the accompanying drawings, in which:

FIG. 1 is a block diagram illustrating a configuration of a mobile terminal according to an exemplary embodiment;

FIGS. 2A and 2B are diagrams illustrating a page mesh according to an exemplary embodiment;

FIG. 3 is a flowchart illustrating a page display method according to an exemplary embodiment;

FIG. 4 is a flowchart illustrating a page deforming method according to an exemplary embodiment;

FIG. 5 is a flowchart illustrating a page skipping method according to an exemplary embodiment;

FIG. 6 is a flowchart illustrating page setting according to an exemplary embodiment;

FIG. 7A is an exemplary diagram of a screen for setting an environment of a mobile terminal according to an exemplary embodiment;

FIG. 7B is an exemplary diagram of a screen for setting an environment of a page according to an exemplary embodiment;

FIGS. 8A to 23 are exemplary diagrams illustrating screens for describing a page display method according to an exemplary embodiment;

FIG. 24 is a flowchart illustrating a page editing method according to an exemplary embodiment; and

FIGS. 25A to 26 are diagrams of screens illustrating a page editing method according to an exemplary embodiment.

### DETAILED DESCRIPTION OF EXEMPLARY EMBODIMENTS

Exemplary embodiments are described with reference to the accompanying drawings in detail. The same reference numbers are used throughout the drawings to refer to the same or like parts. Detailed descriptions of well-known functions and structures incorporated herein may be omitted to avoid obscuring the subject matter of the exemplary embodiments.

The contents display method according to exemplary embodiments may be implemented by a mobile terminal, for example, a smart phone, a tablet PC, an e-book reader, a navigation device, or a moving image player. Hereinafter, the contents display method and the mobile terminal thereof will be described in detail.

As used herein, according to exemplary embodiments, the term ‘contents’ may refer to photographs, videos, audio, images, calendars, contact points, memos, documents, e-books, web pages, and thumb-nails and icons, in addition to many other types of contents. The contents are displayed for each page. The pages according to exemplary embodiments may be convexly and stereoscopically deformed in response to a user gesture. Accordingly, when the user operates a screen on which pages are displayed by a touch input device (e.g., finger or pen), the user may feel as if the user is controlling real paper pages.

As used herein, according to exemplary embodiments, the term ‘page mesh’ refers to geometrical information of the pages. The page mesh includes a plurality of nodes and links connecting the nodes with each other. A weight is allocated to each node, and an elastic value is allocated to each link. The elastic value may be differently allocated for the user according to properties of the pages in order to achieve a realistic feeling.

For example, when the pages are thickly set (that is, when the weight is greatly set), the elastic value may be greatly allocated. When the page is relatively thinly set, the elastic value may be allocated to a relatively smaller value. A great weight may be allocated to nodes located in an inner side (e.g., spine) of the page. When location variation in relatively outer nodes (e.g., page edge) is greater than that of inner nodes, a small weight may be allocated to the relatively outer nodes. The same weight may be allocated to all nodes. According to exemplary embodiments, the weights of the nodes correspond to resistances of the nodes against being convexly deformed due to detected movement. According to exemplary embodiments, the weights of nodes may decrease in a direction moving away from the spine. Alternatively, the weights of the nodes may be equal throughout the displayed page.

Virtual force applied to each node may be classified into two types. The first virtual force is an internal virtual (hereinafter also referred to ‘internal force’). The second virtual force is an external virtual force (hereinafter also referred to ‘external force’) such as gravity or human power. The virtual gravity of the external force is defined as a force pulling the node down. If a screen on which the pages are displayed is arranged in an XY plane and a user's viewpoint is along a positive direction of the Z direction on the XY plane, the virtual gravity pulls the node down toward a lower portion of the XY plane. The Z axis is vertical (orthogonal) to the XY plane. The Z axis is not an actual axis, but is a virtual axis for stereoscopically controlling the virtual page. The virtual gravity may act equally on all nodes. The gravity may have a different effect according to a property of a page to achieve a realistic feeling for the user. For example, in a case where the user lifts and puts down a page of a real paper book, when the page is thin, if the page is relatively thick, the page falls down rapidly down. The following table 1 illustrates thicknesses by types of pages. For example, referring to table 1, a pamphlet falls down faster than a leaflet. That is, a deformation degree of the page may be changed according to thicknesses and materials set to the display page.

TABLE 1

| | | |
|---|---|---|
| Leaflet interposed in newspaper | 52.3 | g/m² |
| Magazine body, advertising papers | 64 | g/m² |
| Tickets, weekly magazines, pamphlets | 127.9 | g/m² |
| Cover of fashion magazine, name cards | 157 | g/m² |
| Sketchbooks | 200 | g/m² |
| Printing papers | 75 | g/m² |

An artificial force is a force which the user applies to the page. For example, a user gesture with respect to the screen may be the artificial force. A target node touched by the touch input device is moved in a direction in which the touch input device is moved. In this case, the artificial force is transferred to other nodes through links. As a result, a sum of the internal force and the external force is applied to each node. If the artificial force is applied to a displayed page, a controller of the mobile terminal calculates forces applied to each node based on the artificial force applied to the displayed page. The force may be obtained in various ways, for example, by multiplying a moving distance of a target node by speed to obtain acceleration, and by multiplying the acceleration by a weight of a corresponding target node. The calculation of the force is generally known in the art, and thus a detailed description thereof is omitted. The mobile terminal reflects a deformed page mesh on a page to generate an animation. A procedure of generating the animation based on the artificial force is defined by a physically-based simulation. The physically-based simulation may be executed by various components, such as, for example, an Application Processor (AP), a Central Processing Unit (CPU), or a Graphics Processing Unit (GPU).

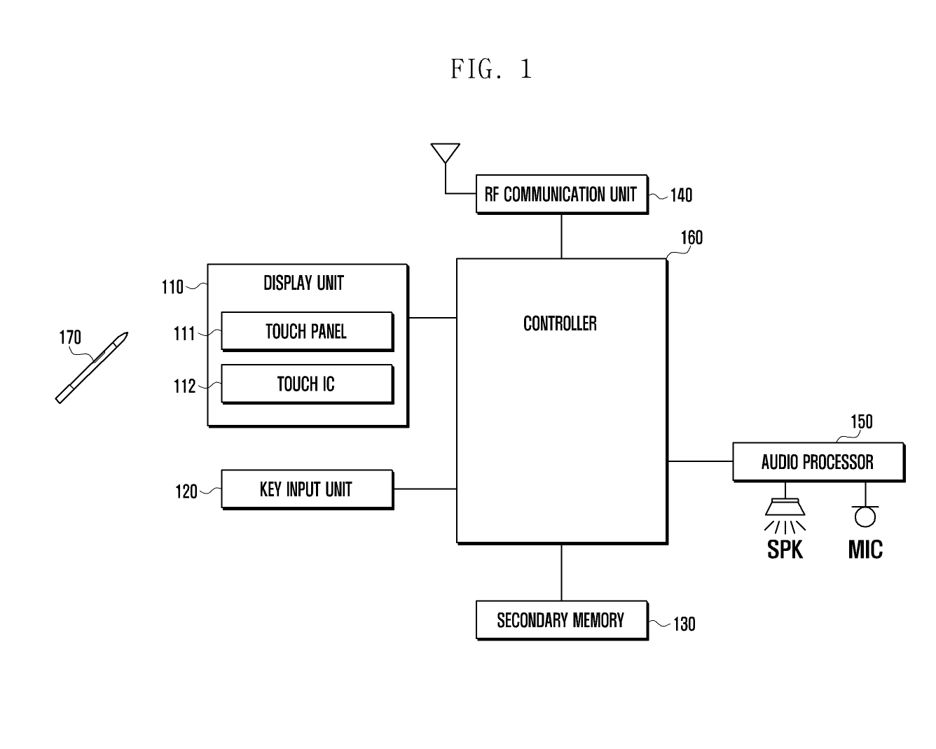

FIG. 1 is a block diagram illustrating a configuration of a mobile terminal according to an exemplary embodiment.

Referring to FIG. 1, the mobile terminal 100 includes a display unit 110, a key input unit 120, a memory 130, a radio frequency (RF) communication unit 140, an audio processor 150, a speaker SPK, a microphone MIC, a controller 160, and a pen 170.

The display unit 110 displays contents on a screen under control of the controller 160. That is, when the controller 160 processes (e.g., performs a decoding or resizing operation) and stores the contents in a buffer, the display unit 110 converts the contents stored in the buffer into an analog signal, and displays the analog signal on the screen. When power is supplied to the display unit 110, the display unit 110 displays a lock image (e.g., login image) on the screen. If lock release information (e.g., password) is detected in a state that a lock image is displayed, the controller 160 releases the lock. That is, the display unit 110 terminates the displaying of the lock image, and displays another image, for example, a home image under control of the controller 160. The home image includes a background image and a plurality of icons displayed thereon. Icons indicate applications or contents, respectively. If the user selects an icon, for example, an application icon (e.g., taps the icon), the controller 160 executes a corresponding application (e.g., gallery), and controls the display unit 110 to display an execution image of the corresponding application (e.g., page including a plurality of thumbnails).

The display unit 110 may be implemented as various types, for example, a Liquid Crystal Display (LCD), an Organic Light Emitting Diode (OLED), an Active Matrix Organic Light Emitting Diode (AMOLED), or a flexible display.

The touch panel 111 is installed on a screen of the display unit 110. For example, the touch panel 111 may be implemented as an add-on type located on a screen of the display unit 110 or an on-cell type or an in-cell type inserted into an inside of the display unit 110.

The touch panel 111 generates an analog signal (e.g., touch event) in response to touch of a touch input device (e.g., finger or pen) with respect to a screen, and a touch IC 112 converts the analog signal into a digital signal, and transfers the digital signal to the controller 160. The touch event includes a touch coordinate (x, y). For example, the touch IC 112 determines a representative coordinate of a plurality of touch coordinates, stores a determined touch coordinate in an internal memory of the touch IC 112, and transfers the touch coordinate stored in the internal memory to the controller 160 in response to a request of the controller 160. The touch coordinate may be a pixel unit. For example, when resolution of a screen is 640 (the number of horizontal pixels)*480(the number of vertical pixels), an X axis coordinate may be, for example, (0, 640), and a Y axis coordinate may be, for example, (0, 480).

When the touch coordinate is received from the touch IC 112, the controller 160 determines that the touch input device (e.g., finger or pen) touches the touch panel 111. When the touch coordinate is not received from the touch IC 112, the controller 160 determines that the touch of the touch input device is released. Further, for example, when the touched coordinate varies from (x0, y0) to (x1, y2), a variation amount of the touched coordinate (e.g., D (D2=(x0−x1)2+(y0-y1)2) exceeds a preset “moving threshold (e.g., 1 mm)”, the controller 160 determines that the touch input device has moved.

The controller 160 computes a location variation amount (dx, dy) of the touch and moving speed of the touch input device in response to movement of the touch input device. The controller 160 determines a user gesture as one of various different types of gestures, for example, touch, multi-touch, tap, double tap, long tap, tap & touch, drag, flick, press, pinch in, and pinch out based on presence of touch release of the touch input device, presence of movement of the touch input device, a location variation amount of the touch input device, and moving speed of the touch input device. The touch is a gesture where a user makes the touch input device contact with one point of a touch panel 111 on a screen. The multi-touch is a gesture where the user makes a plurality of touch input devices (e.g., thumb and index finger) contact the touch panel 111. The tap is a gesture where the user touches-off a corresponding point without movement after touching the touch input device on one point. The double tap is a gesture where a user continuously taps one point twice. The long tap is a gesture where touch of the touch input device is released from a corresponding point without a motion of the touch input device after touching one point longer than the tap. The tap & touch is a gesture where the user touches a corresponding point within a predetermined time (e.g., 0.5 seconds) after touching one point of a screen. The drag is a gesture that moves the touch input device in a predetermined direction in a state in which one point is touched. The flick is an operation that touches-off after moving the touch input device at a higher speed than the drag. The press is a gesture to maintain the touch without movement for a predetermined time (e.g., 2 seconds) after touching one point. The pinch in is a gesture where the user reduces an interval between touch input devices after simultaneously multi-touching two points by the two touch input devices. The pinch out is a gesture for increasing the interval between the touch input devices. That is, the touch is a gesture in which the user contacts the touch screen, and other gestures refer to variations in the touch.

The touch panel 111 may be a converged touch panel including a hand touch panel detecting a hand gesture and a pen touch panel detecting a pen gesture. The hand touch panel may include a capacitive type touch panel. The hand touch panel may also include a resistive type touch panel, an infrared type touch panel, or an ultrasonic type touch panel. Further, the hand touch panel does not generate a touch event only based on a hand gesture, but may also generate the touch event based on other objects touching the touch panel 111 (e.g., conductive material capable of providing variation in capacitance). The pen touch panel may include an electromagnetic induction type touch panel. Accordingly, the pen touch panel generates a touch event by a specially manufactured touch pen 170 so that a magnetic field may be formed. In particular, the touch event generated by the pen touch panel includes a value indicating a type of the touch together with a touch coordinate. For example, when a first voltage level is received from the pen touch panel, the controller 160 determines a touch of the touch input device as an indirect touch (that is, hovering). When a second voltage level greater than the first voltage level is received from the touch panel 111, the controller 160 determines the touch of the touch input device as a direct touch. The touch event generated by the pen touch panel may further include a value indicating the presence of pushing of a button installed at the pen 170. For example, when a button installed at the pen 170 is pushed, a magnetic field generated from a coil of the pen 170 varies. In response to the variation in the magnetic field, the pen touch panel generates a third voltage level, and transfers the third voltage level to the controller 160. According to exemplary embodiments, the detecting of movement includes detecting a touch input device touching the touch input unit. According to exemplary embodiments, the detecting of movement includes detecting a voltage level of the touch input device.

The key input unit 120 may include a plurality of input keys and function keys for receiving numeric or character information and setting various functions. The keys may include a menu loading key, a screen on/off key, a power on/off key, and a volume control key. The key input unit 120 generates a key event associated with user settings and function control of the mobile terminal 100 and transfers the key event to the controller 160. The key event may include a power on/off event, a volume control event, a screen on/off event, and a shutter event. The controller 160 controls the foregoing constituent elements in response to the key event. Meanwhile, a key of the key input unit 120 may refer to a hard key and a virtual key displayed on the display unit 110 may refer to a soft key.

The secondary memory 130 may include various components, such as a disk, a RAM, a ROM, and a flash memory. The secondary memory 130 stores contents generated by the mobile terminal 100 or contents received from an external device (e.g., server, desktop PC, tablet PC) through the RF communication unit 140. The secondary memory 130 may temporarily store data copied from a message, a photograph, a web page, and a document by the user for performing a copy and paste operation. The secondary memory 130 stores various preset values (e.g., screen brightness, presence of vibration upon generation of a touch, presence of automatic rotation of screen). Further, the memory 130 stores histogram information, for example, information associated with a most recently displayed page before the application is terminated.

The secondary memory 130 stores a booting program, and at least one operating system (e.g., gallery, address book, video player, calendar, note pad, electronic book viewer, music player, web browser). The operating system serves as an interface between hardware and applications and further serves as an interface between applications, and manages various computer resources, such as a CPU, a graphic processing unit (GPU), a main memory, and the secondary memory 130. The applications may be classified into an embedded application and a third party application. For example, the embedded application includes a web browser, an e-mail program, and an instant messenger. If power of a battery is supplied to the controller 160 of the mobile terminal 100, the booting program is loaded into a main memory of the controller 160. The booting program loads host and guest operating systems into the main memory 161. The operating systems load the application into the main memory 161.

The RF communication unit 140 performs voice calls, image calls, and data communications with an external device through a network under the control of the controller 160. The RF communication unit 140 may include an RF transmitter for up-converting a frequency of a transmitted signal and amplifying the converted signal, and an RF receiver for low-noise-amplifying a frequency of a received signal and down-converting the amplified signal. The RF communication unit 140 may include a mobile communication module (e.g., 3-generation mobile communication module, 3.5-generation mobile communication module, 4-generation mobile communication module, etc.), a digital broadcasting module (e.g., DMB module), and a near field communication module.

The audio processor 150 inputs and outputs an audio signal (e.g., voice data) for voice recognition, voice recording, digital recording, and call operations. The audio processor 150 receives an audio signal from the controller 160, converts the received audio signal into an analog signal, amplifies the analog signal, and outputs the amplified analog signal through the speaker SPK. The audio processor 150 converts an audio signal received from the microphone MIC into digital data, and provides the converted digital signal to the controller 160. The speaker SPK converts an audio signal received from the audio processor 150 into a sound wave and outputs the sound wave. The MIC converts the sound wave received from a person or other sound source into the audio signal.

The controller 160 controls overall operations and signal flows between internal constituent elements of the mobile terminal 100, processes data, and controls supply of power from a battery to the constituent elements. The controller 160 includes at least one CPU. As is generally known in the art, the CPU is a core control unit of a computer system and performs computation and comparison of data, and interpretation and execution of commands. The CPU includes various registers which temporarily store data and commands. The controller 160 may include at least one Graphic Processing Unit (GPU). The GPU is a graphic control unit performing computation and comparison of data associated with graphics, and interpretation and execution of commands, alternatively to the CPU. Each of the CPU and the GPU may be configured by integrating at least two independent cores (e.g., quad-core) as one package being a single IC. The CPU and the GPU may be implemented as a System on Chip (SoC). The CPU and the GPU may be a package of a multi-layer structure. A configuration including the CPU and the GPU may be referred to as an Application Processor (AP).

The GPU of the controller 160 deforms a page mesh in response to a gesture (e.g., drag) of a touch input device, and generates an animation by reflecting a page on the deformed page mesh. The GPU receives information associated with a touch gesture from the touch IC 112. The GPU deforms the page mesh using the received information. If a touch of the touch input device is released from a screen, the GPU restores the page mesh to an original state. That is, the deformed page mesh is restored to an original state by the elastic force of links and gravity applied to each node. The GPU accesses the secondary memory 130 to read a page therefrom. The GPU reflects deformation information of the page mesh on the read page to generate the animation. The deformation information of the page mesh includes coordinates (x, y, z) of each node constituting the page mesh. In addition, the GPU controls the display unit 110 to display the animation. The animation may be generated by a CPU or an application processor (AP).

The controller 160 includes a main memory, for example, a RAM. The main memory may store various programs, for example, a booting program, a host operation system, guest operating systems, and applications loaded from the secondary memory 130. The CPUs and GPUs of the controller 160 access the foregoing program to decode a command of the program and execute a function (e.g., generation of histogram) according to the interpretation result. In addition, the controller 160 temporarily stores data to be written in the secondary memory 130 and temporarily stores data read out from the secondary memory 130. A cache memory may be further provided as a temporary data warehouse.

The pen 170 is an accessory of the mobile terminal 100 which can be separated from the mobile terminal 100, and may include, for example, a penholder, a rib disposed at an end of the penholder, a coil disposed inside the penholder adjacent to the rib to generate a magnetic field, and a button which varies the magnetic field. The coil of the pen 170 forms the magnetic field around the rib. A pen touch panel of the touch panel 111 detects the magnetic field, and generates a touch event corresponding to the magnetic field.

According to exemplary embodiments, the mobile terminal 100 may further include constituent elements which are not described above, such as a Global Positioning System (GPS) module, a vibration motor, and an acceleration sensor.

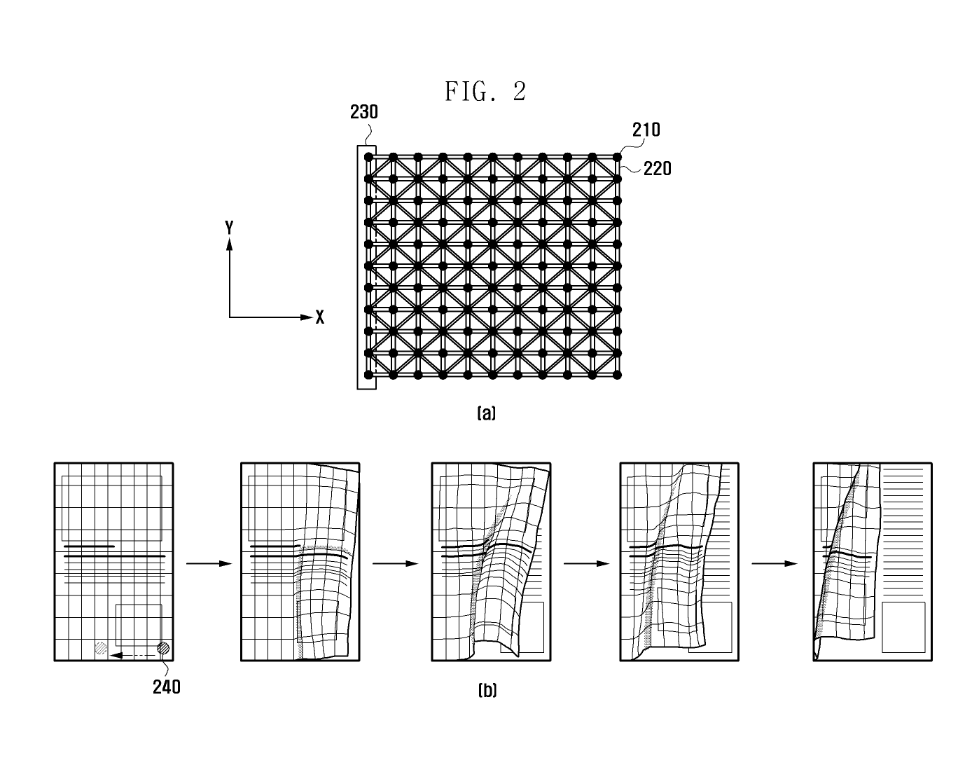

FIGS. 2A and 2B show a diagram illustrating a page mesh according to exemplary embodiments. Referring to FIG. 2A, the controller 160, and particularly, a CPU of the controller 160, configures a page mesh. The page mesh includes a plurality of nodes and a plurality of links connecting the nodes with each other. In FIG. 2A, reference numeral 210 represents a plurality of nodes, and reference numeral 220 represents a plurality of links. As shown in FIG. 2A, a plurality of nodes may be arranged in a matrix pattern, and locations thereof may be represented by XY coordinates. Further, as described above, a suitable weight is allocated to each node, and a suitable elastic value is allocated to each link (spring). A relatively heavyweight may be allocated to nodes which are located at a center 230 of the page mesh. A relatively light weight may be allocated to outer nodes located relatively away from the center 230 as compared with nodes located near the center 230. Accordingly, the nodes have a movement which is gradually lighter in an outward direction. Nodes react gradually more sensitively to a touch gesture in the direction towards an outer node. When the page is skipped (turned), nodes located at a central axis (Y axis) 230 are fixed, which is different from other nodes.

Alternatively, the same weight may be allocated to all nodes. As such, the entire movement of the page mesh may be heavier than a previous case in which different weights are allocated to the nodes. That is, a deformation degree of the page may be changed according to attribute information (e.g., thickness, weight, material) set to a corresponding page. Further, the deformation degree of the page may be changed according to a calculated gradient. When an artificial force (that is, gesture of touch input device) is applied to the page, the controller 160, particularly, a GPU of the controller 160, detects a gesture, deforms the page mesh in response to the detected gesture, and reflects the deformed page mesh on the page to generate an animation. In detail, referring to FIG. 2B, the user touches a right bottom peripheral point 240 of a page by a touch input device (e.g., finger, pen). Then, the controller 160 detects a target node touched by the touch input device. Next, the user moves the touch input device from the right bottom peripheral point 240 to a left direction. Accordingly, the controller 160 moves the target node to the left direction on an XY plane according to movement of the touch input device. That is, the target node is moved in a direction which is vertical to gravity.

The controller 160 calculates displacement of the moved target node. The displacement may be represented as a vector having a size and a direction. In detail, the size of the displacement includes at least one of a current location of the target node, a moved distance of the target node, and speed of the target node. For example, the size of the displacement may include only a current location of the target node, only a moved distance of the target node, only speed of the target node, or a combination of the current location of the target node, the moved distance of the target node, and the speed of the target node. The controller 160 deforms the page mesh according to the computed gradient, and reflects the deformed page mesh on the page to generate the animation. The controller 160 calculates forces applied to each node using the calculated displacement. The force is a vector having a size and a direction. As described above, the force is a sum of an elastic force, gravity, and an artificial force. The controller 160 calculates location values of respective nodes using the calculated forces. As shown in FIG. 2B, the controller 160 generates the animation (deformed page) as shown in FIG. 2B using the calculated location values. Meanwhile, the controller 160 may move the target node in a direction which is vertical to gravity. That is, a value of a Z axis may vary or be ‘0’ according to variations in a value of an X axis and a value of a Y axis of the target node. The controller 160 fixes a node located at a central axis 230 so that the node located at the central axis 230 functions in a different fashion from other nodes. As such, exemplary embodiments achieve a realistic effect of the user pushing and moving a page of a paper book in a real-time manner. Accordingly, as shown in FIG. 2B, the deformed page has a convex shape. As described above referring to FIGS. 2A and 2B, the page mesh may be variously deformed in a realistic fashion according to the touch coordinates, a moving direction, and moving speed of the touch input device. Accordingly, the user may experience a feeling of interacting with pages of a real paper book according to the exemplary embodiments.

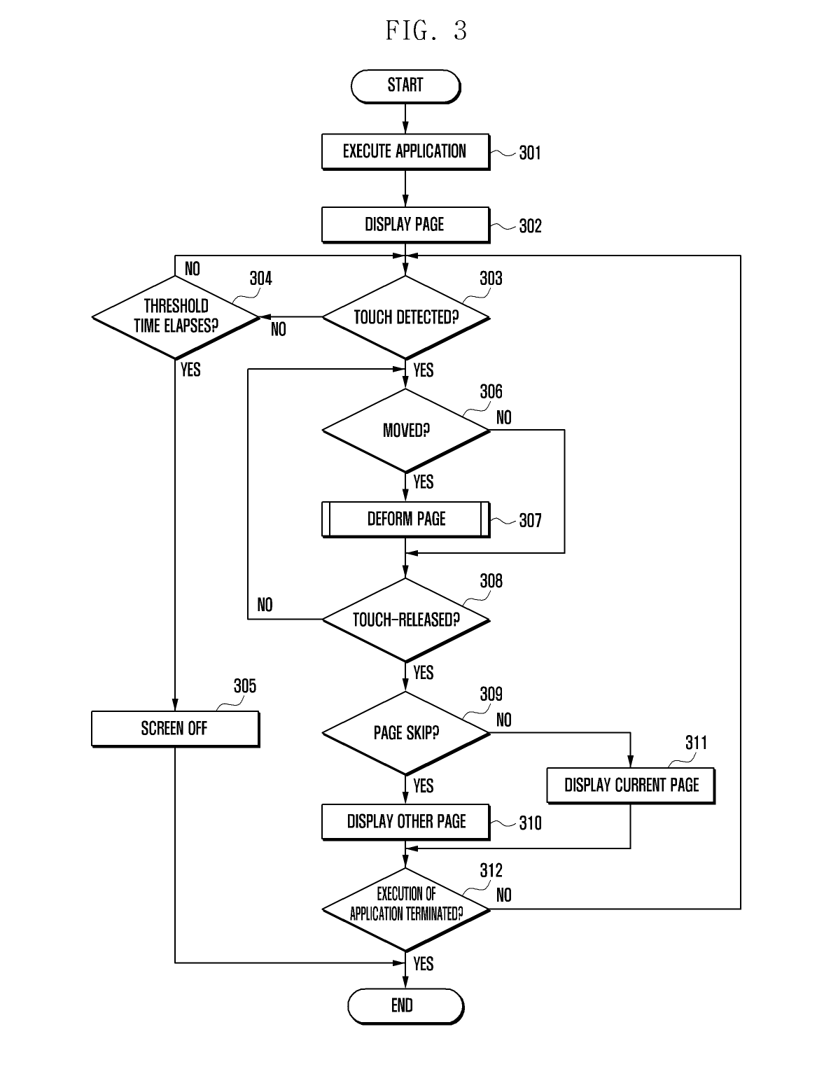

FIG. 3 is a flowchart illustrating a page display method according to an exemplary embodiment.

Referring to FIG. 3, a controller 160 may initially be in an idle state. For example, a display unit 110 displays a home image including a plurality of icons. The controller 160 detects a tap of the touch input device with respect to the icon. The controller 160 executes a corresponding application (e.g., loads pages of a corresponding application to a main memory) in response to the tap (operation 301). For example, the executed application may include a gallery, an address book, a video player, an electronic book viewer, a music player, or a web browser. The controller 160 selects at least one page (e.g., most recently displayed page before a corresponding application is terminated) of pages of the executed application, and controls the display unit 110 to display the selected page (operation 302).

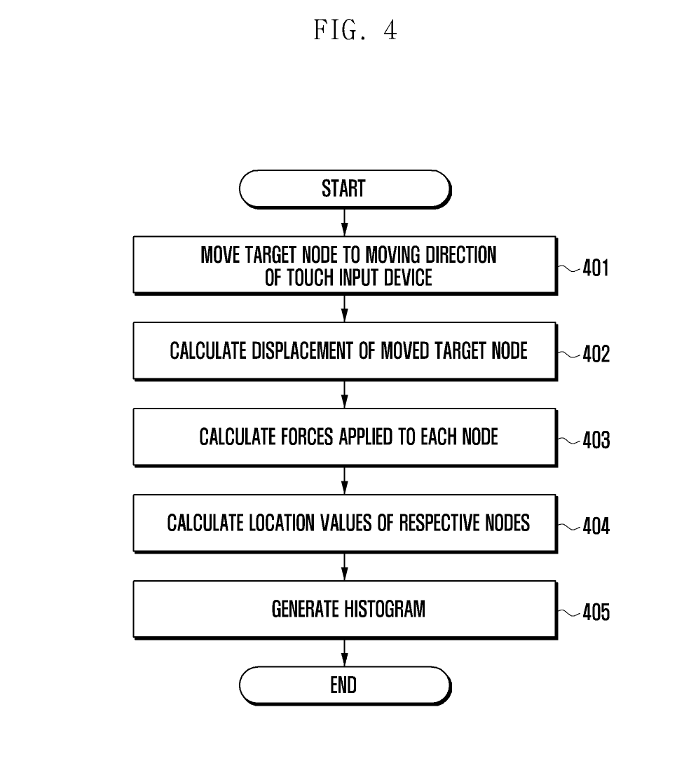

The controller 160 determines whether a touch is detected (operation 303). When the touch is not detected, the controller 160 determines whether a threshold time elapses (operation 304). The threshold time is set to automatically turn-off the screen. If the touch is not detected by the time the threshold time elapses, the controller 160 turns-off the screen (operation 305). The threshold time may be set to many different values, e.g., 1 minute, which may be changed according to selection of the user. When the touch is detected, the controller 160 determines whether the touch input device is moved (e.g., drag, flick) (operation 306). When the touch input device is moved, the controller 160 controls the display unit 110 to display a convexly deformed page in response to the movement of the touch input device (operation 307). That is, the controller 160 deforms the page mesh in response to the movement of the touch input device, and reflects the deformed page mesh on the page to generate the animation. A detailed process of step 307 will be described with reference to FIG. 4.

The controller 160 determines whether the touch of the touch input device is released from the screen (operation 308). If the touch of the touch input device is maintained without releasing the touch, the process returns to operation 306. Conversely, if the touch input device is touch-released, the process proceeds to operation 309. The controller 160 determines whether the touch release is an event corresponding to a page skip (operation 309). That is, the controller 160 determines whether the page skip is generated based on at least one of a moving direction of the touch input device, a touch coordinate and speed before generation of the touch release. When the page skip is generated, the controller 160 controls the display unit 110 to skip a currently display page and to display another page (operation 310). When the page skip is not generated, the controller 160 maintains the displaying of a current page (operation 311). Next, the controller 160 determines whether execution of the application is terminated (operation 312). When the execution of the application is not terminated, the process returns to operation 303.

FIG. 4 is a flowchart illustrating a page deforming method according to an exemplary embodiment. Referring to FIG. 4, a controller 160 detects a target node touched by a touch input device. Further, the controller 160 detects a moving direction of the touch input device. The controller 160 moves the target node to a moving direction of the touch input device (operation 401). Particularly, the controller 160 may move the target node to a direction vertical to a gravity direction. The controller 160 may move the target node at a determined gradient (e.g., −30°˜+30°) based on the gravity direction. Next, the controller 160 calculates displacement of the moved target node (operation 402).

The displacement is represented by a vector having a size and a direction. In detail, the size of the displacement may include at least one of a current location of the target node, a moved distance of the target node, and speed of the target node. For example, the size of the displacement may include only a current location of the target node, only a moved distance of the target node, only a speed of the target node, or a combination of the current location of the target node, the moved distance of the target node, and the speed of the target node.

After calculating the displacement, the controller 160 calculates forces applied to each node using the calculated displacement of the target node (operation 403). The calculation of the forces is generally known in the art. That is, the controller 160 calculates a magnitude of forces applied to each node and a direction to which the forces are applied (operation 403). Next, the controller 160 applies the calculated forces to each node to deform a page mesh (operation 404). That is, the controller 160 calculates location values of respective nodes using the calculated forces (operation 404). Finally, the controller 160 applies the deformed page mesh to a page to generate an animation (operation 405). The generated histogram is displayed such that the page is convexly deformed as the target node is moved to a direction vertical to gravity or a determined direction of a gradient. According to exemplary embodiments, the changing the appearance of the page includes turning the page over to a next page. According to exemplary embodiments, the displaying of the page includes displaying two pages connected at a spine, and the weights of the nodes corresponding to the spine are greater than weights of other nodes of the two pages. According to exemplary embodiments, the displayed page corresponds to a type of material, and the weights of the nodes correspond to the type of material.

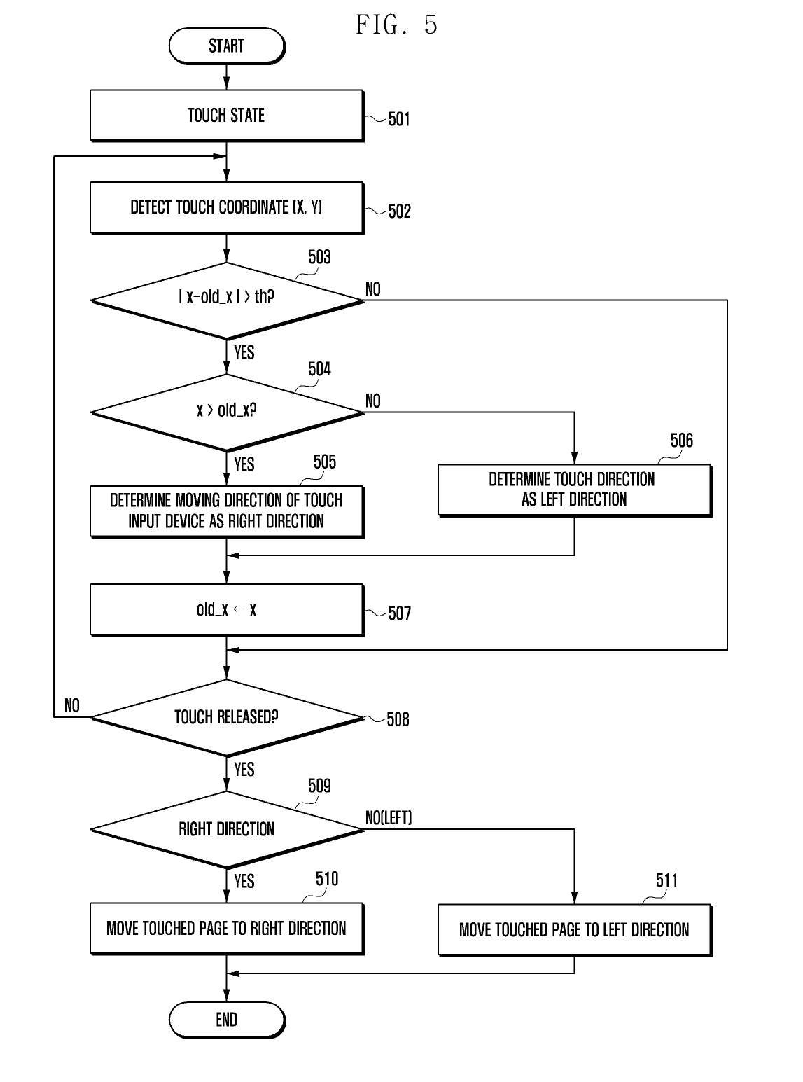

If the touch of the touch input device is released from the deformed page, the page is restored to an original state, that is, an open state. In this case, the page may be skipped or may not be skipped and returned to an original position. Such a result is determined by forced applied to respective nodes of the page mesh. That is, if an artificial force disappears, only the elastic force and the gravity are applied to the page mesh. The controller 160 calculates a sum of forces applied to respective nodes of the page mesh. The controller 160 determines a moved direction of the page based on the sum of the forces. The controller 160 moves the page along the determined direction. For example, the page is moved in a direction towards which a mass center of the page mesh faces. The moving direction of the page is determined as a moving direction before the touch input device is separated from a screen (that is, a page). A detailed example will be described with reference to FIG. 5.

FIG. 5 is a flowchart illustrating a page skipping method according to an exemplary embodiment.

Referring to FIG. 5, a display unit 110 displays a page, and a touch input device of a user touches the displayed page (operation 501). While the touch input device touches the page, the controller 160 detects a current touch coordinate (x, y) (operation 502). It is assumed that the X axis is a horizontal axis based on a viewpoint at which the user views a screen. It is assumed that two pages are displayed, one page at a left side and the other page at a right side, based on a center line of a screen. Further, a right direction is a positive direction of an X axis, and a left direction is a negative direction of the X axis. Under the assumption, a controller 160 determines whether “|x−old_x|>th” is satisfied (operation 503). The value “x” is a current touch coordinate, the value “old_x” is a previous touch coordinate, and the “th” is a preset threshold value. For example, the “th” may be set to 5 mm, although is not limited thereto. When “|x−old_x|>th” is not satisfied, the process proceeds to operation 508. Conversely, when “|x−old_x|>th” is satisfied, that is, a difference between the current touch coordinate and the previous touch coordinate exceeds the threshold value, the process proceeds to operation 504.

The controller 160 determines whether the current touch coordinate is greater than the previous touch coordinate (operation 504). When the current touch coordinate is greater than the previous touch coordinate, the controller 160 determines a moving direction of the touch input device as a ‘right direction’ (operation 505). When the current touch coordinate is less than or equal to the previous touch coordinate, the controller 160 determines the touch direction as a ‘left direction’ (operation 506). After the moving direction is determined, the controller 160 sets the current touch coordinate to the previous touch coordinate (operation 507). Next, the controller 160 determines whether a touch of the touch input device is released from the screen (operation 508). When the touch of the touch input device is not released, the process returns to operation 502. Conversely, when the touch of the touch input device is released, the controller 160 determines whether the determined touch direction is a right direction (operation 509). When the touch direction is the right direction, the controller 160 moves the touched page to the right direction (operation 510). If the touched page is a left page, operation 510 corresponds to an operation of skipping the page to a previous page. When the touched page is a right page, operation 510 corresponds to an operation of maintaining the displaying of the touched page without skipping the page to the next page. When the touch direction is the left direction, the controller 160 moves the touched page to the left direction (operation 511). If the touched page is the left page, operation 511 corresponds to an operation of maintaining the displaying of the touched page without skipping the page back. Conversely, if the touched page is the right page, step 511 corresponds to an operation of skipping the page to a next page.

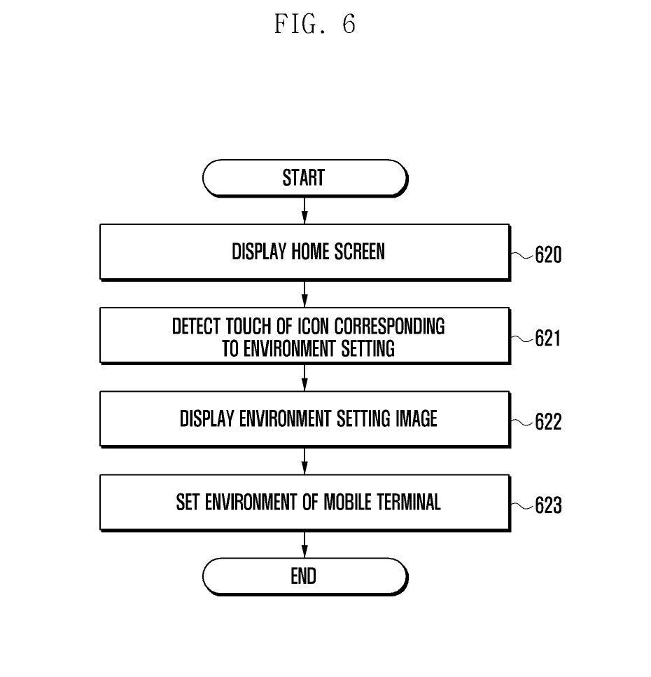

FIG. 6 is a flowchart illustrating page setting according to an exemplary embodiment. Referring to FIG. 6, a controller 160 may control a display unit 110 to display a home image (operation 620). The home image includes an icon corresponding to an environment setting. The controller 160 detects a touch of an icon corresponding to the environment setting (operation 621). Then, the controller 160 controls the display unit 110 to display an environment setting image of the mobile terminal 100 (operation 622). The controller 160 sets an environment of the mobile terminal, particularly, an environment with respect to the page, according to an operation of a user with respect to the screen (operation 623). Preset values associated with the page are stored in the secondary memory 130. When the page stored in the secondary memory 130 is displayed, the preset values are used by the controller 160.

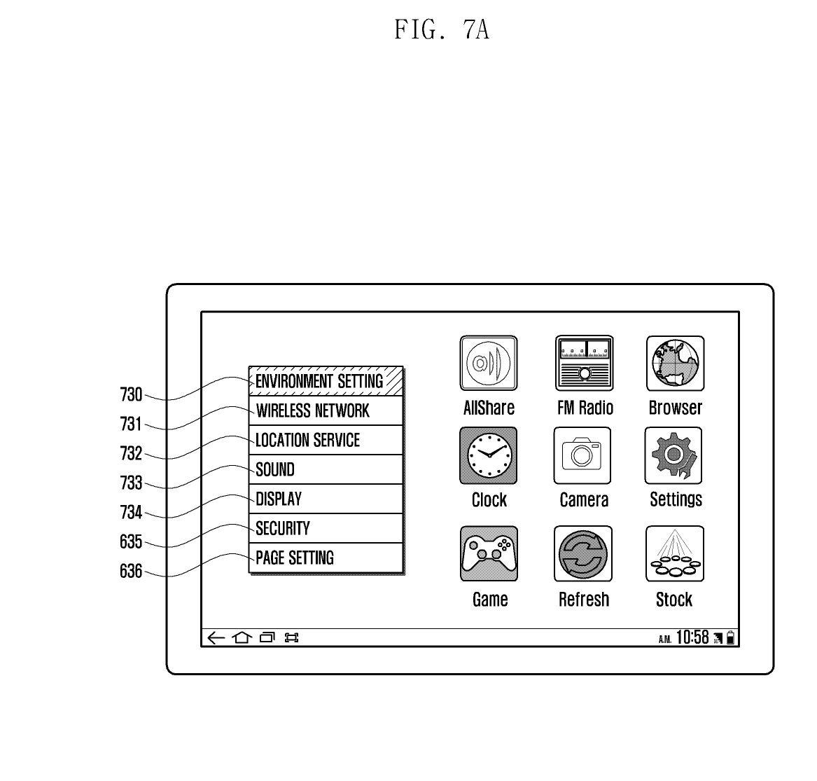

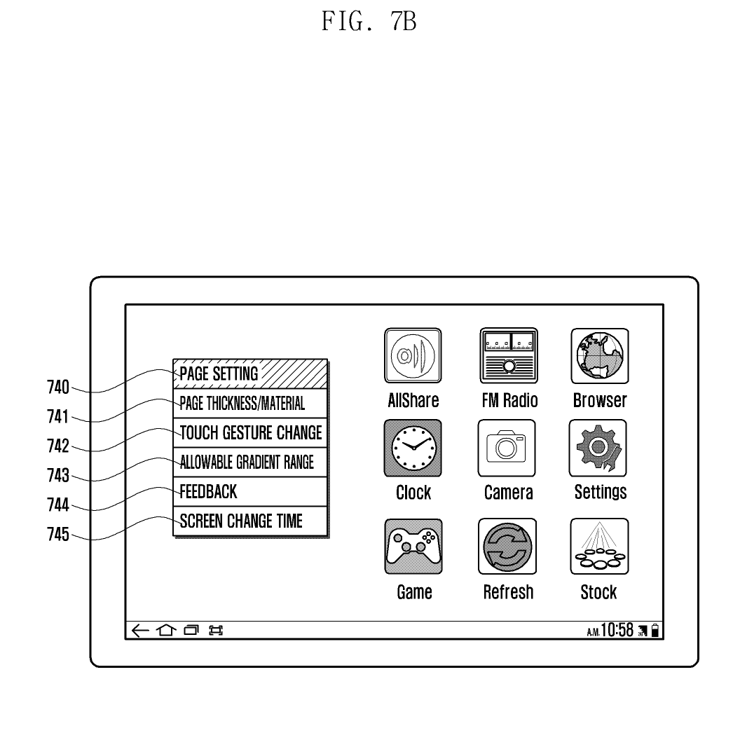

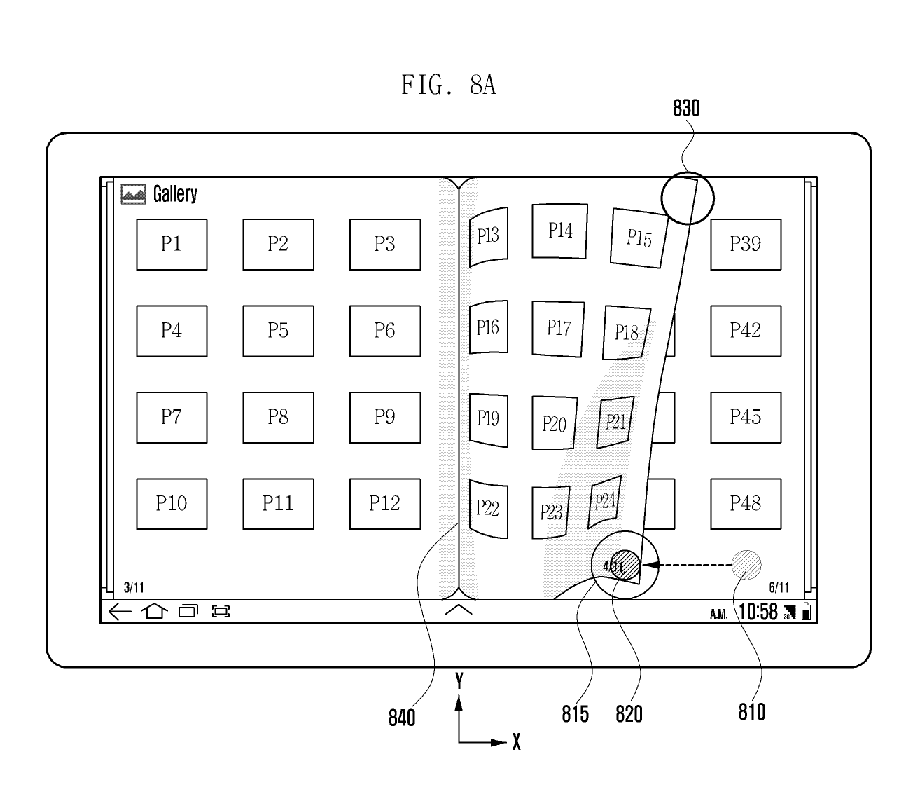

FIG. 7A is an exemplary screen diagram for setting an environment of a mobile terminal according to an exemplary embodiment. Referring to FIG. 7A, the display unit 110 displays an environment setting image 730 under the control of the controller 160. The environment setting image 730 include items such as a wireless network 731, a location service 732, a sound 733, a display 734, a security 735, and page setting 736. The user touches the page setting 736 from the foregoing items. Then, the controller 160 controls the display unit 110 to display a page setting image for setting the environment of the page.

FIG. 7B is an exemplary screen diagram for setting an environment of a page. Referring to FIG. 7B, the display unit 110 displays a page setting screen 740 under control of the controller 160. The page setting screen 740 includes items such as page thickness/material 741, touch gesture change 742, an allowable gradient range 743, feedback 744, and a screen change time 745. As illustrated in table 1, the page thickness/material 741 may be, for example, 75 g/m2 and a printing page. The page thickness/material 741 is set by a manufacturer of an electronic book, and may not be changed by the user. The touch gesture change 742 is an item which changes an allowed touch gesture so the page may be skipped. For example, the touch gesture which is allowed for page skip may be changed from flick to drag or vice versa. An allowable gradient range 743 where the target node is movable may be in the range of −30° to +30°. The feedback 744 is an item for determining feedback to be provided to the user when the page is skipped. For example, the user may set a vibration effect and a sound effect as the feedback. For example, the screen change time 750 may be set to 0.5 seconds.

Hereinafter, exemplary embodiments will be described with reference to exemplary screen diagrams. A display mode of a screen according to the exemplary embodiments may be divided into a landscape mode and a portrait mode. In a case of the landscape mode, the mobile terminal 100 displays two pages toward the left and right directions. In a case of the portrait mode, the mobile terminal displays one page. However, the exemplary embodiments are not limited thereto. If the user rotates the mobile terminal 100, a sensor (e.g., acceleration sensor) included in the mobile terminal 100 detects rotation information and transfers the rotation information to the controller 160. The controller 160 may determine the display mode of the mobile terminal 100 using the rotation information. The exemplary embodiments may use the landscape mode and the portrait mode as the display mode.

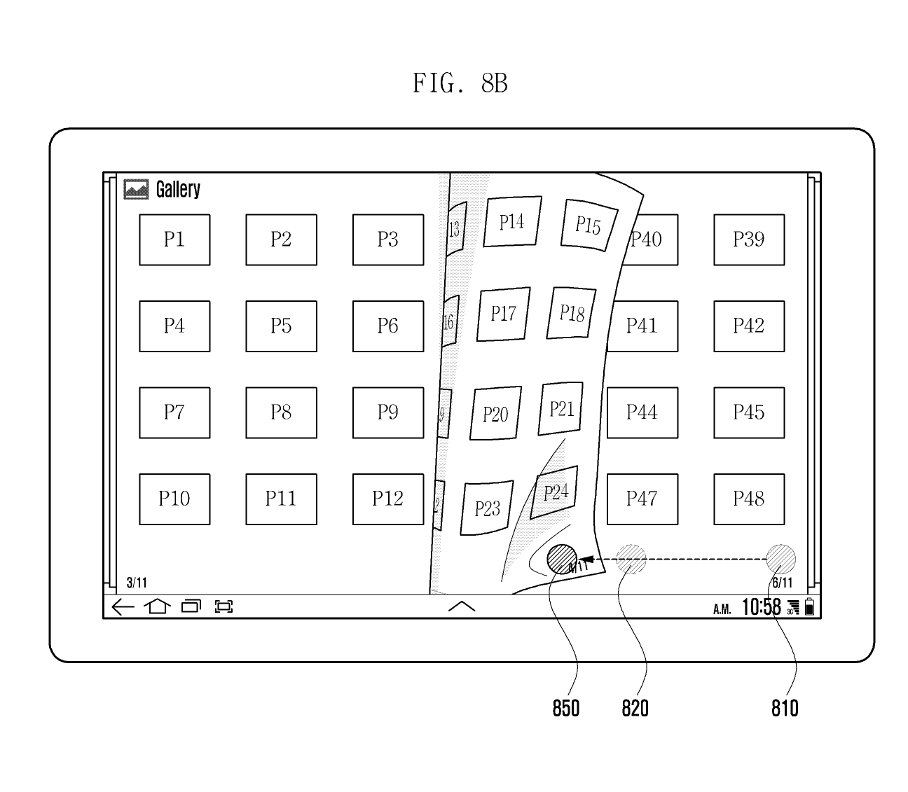

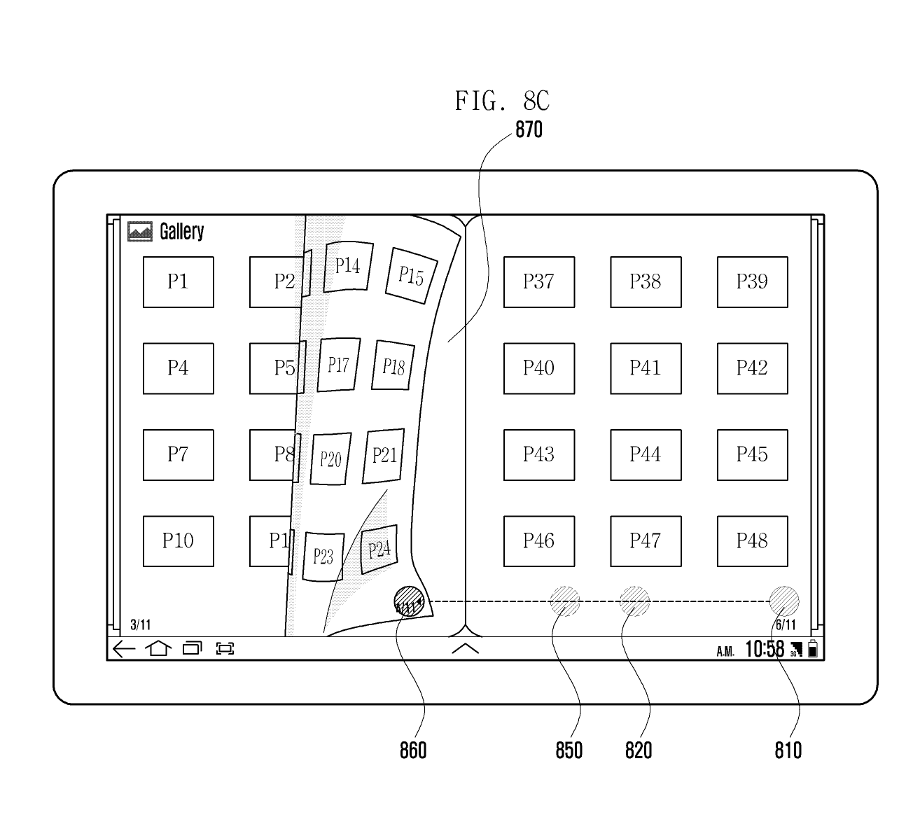

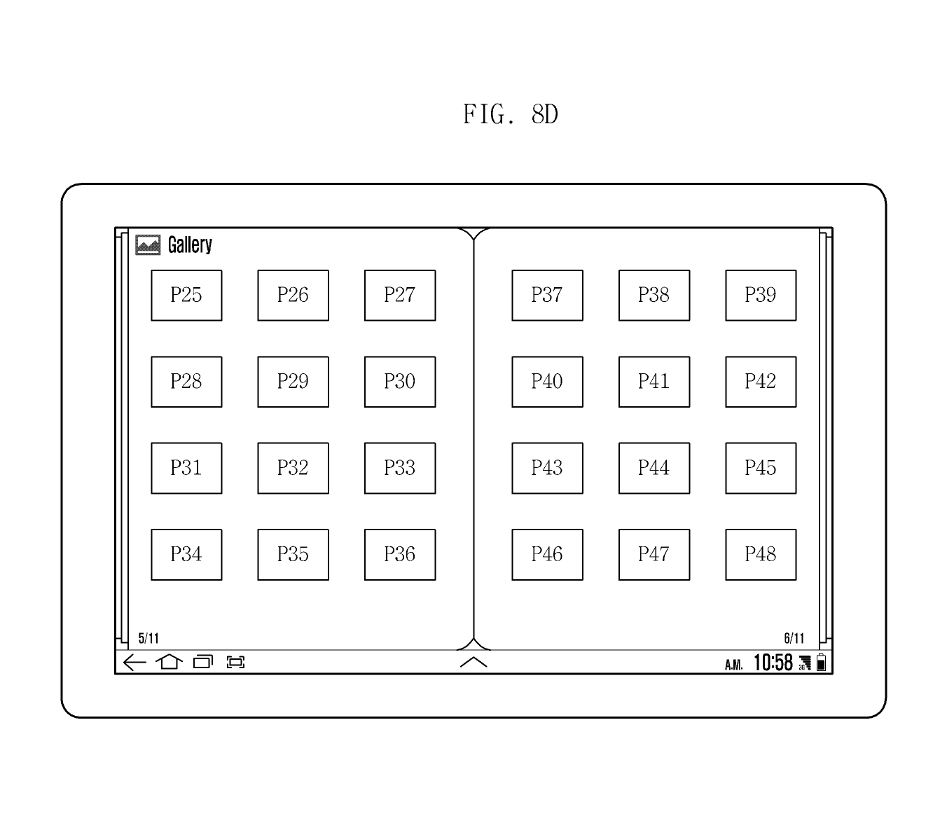

FIGS. 8A to 23 are exemplary screen diagrams illustrating a page display method according to an exemplary embodiment. As described above, the controller 160 moves a target node to convexly deform the page. Although a shape of a page is convex, a concrete shape of the page is changed according to touched information (e.g., touched location, moving direction, moving distance, speed). As used herein, according to exemplary embodiments, the term ‘contents’ may refer to, for example, photographs, videos, audio, images, calendars, contact points, memos, documents, e-books, web pages, thumb-nails, and icons. The contents are displayed for each page. Contents of which the number of pages vary may include photographs, videos, audio, images, contact points, memos, documents, thumb-nails, and icons. Contents of which the number of pages do not vary may include calendars, e-books, and web pages.

FIGS. 8A to 16 illustrate screens on which pages of a gallery are displayed. A plurality of icons (e.g., 12 icons as illustrated above) is included for each page. The number of icons displayed for each page may be changed by a user. Each icon corresponds to an icon or a photograph. For example, when the user taps the icon, a corresponding photograph (or moving image) is displayed on the screen. Further, the page may include other contents, for example, photographs or thumbnails instead of icons. In addition, the page may include various types of contents (e.g., icons, photographs, thumbnails).

Referring to FIG. 8A, the user touches the touch input device on a right bottom peripheral point 810 of a right page (e.g., 4/11 page) of the gallery. Then, the controller 160 detects the target node (or touch coordinate) corresponding to the right bottom peripheral point 810. The user moves the touch input device in a left bottom direction in a state in which the right bottom peripheral point 810 is touched. Then, the controller 160 moves the target node in a left direction from a right bottom area. The controller 160 calculates displacement of the moved target node. In detail, the controller 160 calculates a current location value of the target node (that is, a current touch coordinate of the touch input device), moving speed and direction of the target node. The controller 160 calculates forces applied to each node using the calculated displacement. The controller 160 calculates location values (coordinates) of respective nodes using the calculated forces. The controller 160 generates the animation using the calculated location values. In addition, the controller 160 controls the display unit 110 to display the generated animation. FIG. 8A illustrates an animation (that is, a deformed shape of page) when the touch input device moves from the right bottom peripheral point 810 in a left direction from a right bottom area and is located at a first lower side point 820. As shown in FIG. 8A, the page is greatly deformed and becomes convex in a moving direction (810->820) of the target node. A corner region 815 having the target node is compared with another corner region 830 so that the corner region 815 approaches a spine 840.

Referring to FIG. 8B, the user move the touch input device from the first lower side point 820 towards a left bottom periphery. Then, the controller 160 generates the animation, and controls the display unit 110 to display the generated animation. That is, FIG. 8B illustrates an animation in which the touch input device is located at a second lower side pointer 850. Upon comparison of FIG. 8B with FIG. 8A, the page of FIG. 8B is more convex than a page of FIG. 8A. Accordingly, if the touch of the touch input is released, the page of FIG. 8A is not skipped but the page of FIG. 8B may be skipped. In other words, in a case shown in FIG. 8A, when the user release the touch from the first lower side point 820, a direction of a force (that is, mass center) may act in a rightward direction. Accordingly, the page is not skipped but instead returns to an original position. In a case shown in FIG. 8B, when the user releases a touch from the second lower side point 850, the direction of the force may act in a leftward direction. Accordingly, the page may be skipped to an opposite side. As a result, a direction of the mass center may be associated with a current touch coordinate. Also, even in the case shown in FIG. 8A, there may be a skip condition. An example of the condition will be described in detail. The page skip may be determined according to speed when the touch input device is moved from the right bottom peripheral point 810 to a first bottom side point 820. For example, when a touch of the touch input device is released after the touch input device is moved at a speed greater than or equal to 30 cm/sec, the page may be skipped. When the speed is less than 30 cm/sec, the page may not be skipped. Many other examples of page skip conditions may also be implemented.

Referring to FIGS. 8B to 8D, the user may move the touch input device from the second bottom point 850 to a left side in a state that the touch continuously is maintained. That is, the user moves the touch input device to the first left point 860 through a central line. Then, the controller 160 controls a part 870 of a rear surface (e.g., page 5) of a currently operated page. If the user releases the touch from the first left point 850, as shown in FIG. 8D, the controller 160 displays the entire rear surface on a left side. In this manner, when the touch input device is moved from the right side to the left side through the central line, a rear surface of the page is displayed. When the touch is released after passing through the central line, the page is skipped. Although the touch input device does not pass through the central line, a rear surface of the currently operated page may be displayed. For example, if the touch input device approaches the central line within a preset threshold value (e.g., 10 mm from the central line), the controller 160 may control the display unit 110 to display the rear surface. A threshold for displaying the rear surface may be set to values other than 10 mm. Hereinafter, an example of another exemplary screen according to an exemplary embodiment is described. Repetitive descriptions with respect to FIGS. 8A to 8D are omitted.

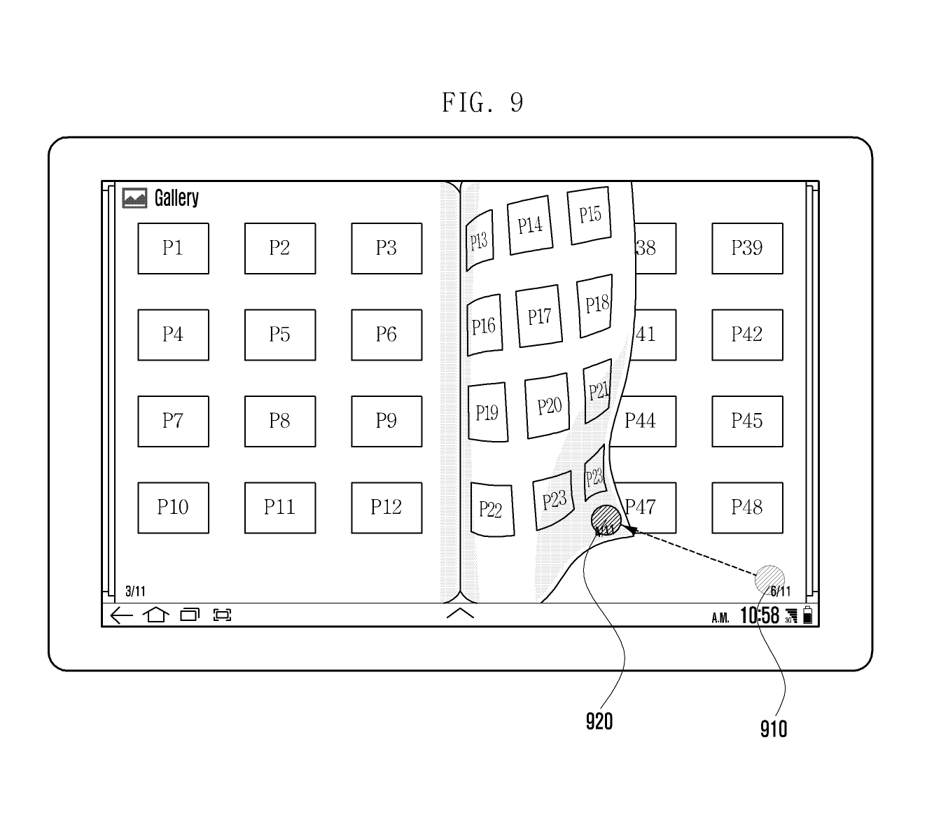

Referring to FIG. 9, the user touches a touch input device at a right bottom peripheral point 910 of a page (e.g., page 4/11) and moves the touch input device from the right bottom point towards a left top area in an upwardly left direction. Then, the controller 160 generates an animation and controls the display unit 110 to display the generated animation. That is, FIG. 9 illustrates an animation when the touch input device is moved from the right bottom peripheral point 910 towards a left top periphery and is located at the third bottom side point 920. Upon comparison of FIG. 9 with FIG. 8A, the touch input devices in FIG. 8A and FIG. 9 start from the same right bottom peripheral point but moving directions thereof are different from each other. Accordingly, shapes of deformed pages are different from each other. Further, when the user releases the touch, the page in FIG. 8A is not skipped but the page in FIG. 9 may be skipped to a left side. Touches shown in FIGS. 8A and 9 start from the same right bottom periphery of the page. However, a moving direction of the case shown in FIG. 8A is along a periphery but a moving direction of a case shown in FIG. 9 is along a center of the page. Accordingly, in a case shown in FIG. 8A, a lower portion of the page has a mass center of a left side, and an upper portion of the page has a mass center of a right side. In this case, the overall mass center may be towards a right side. As a result, the page is not skipped. Conversely, in the case of FIG. 9, since a moving direction of the touch is towards a center of the page rather than along a periphery, upper/lower portions of the page have a mass center towards a left side. As a result, the page is skipped. As a result, a direction of the mass center of the page may be associated with the moving direction of the touch input device as well as a current touch coordinate and speed of the touch input device.

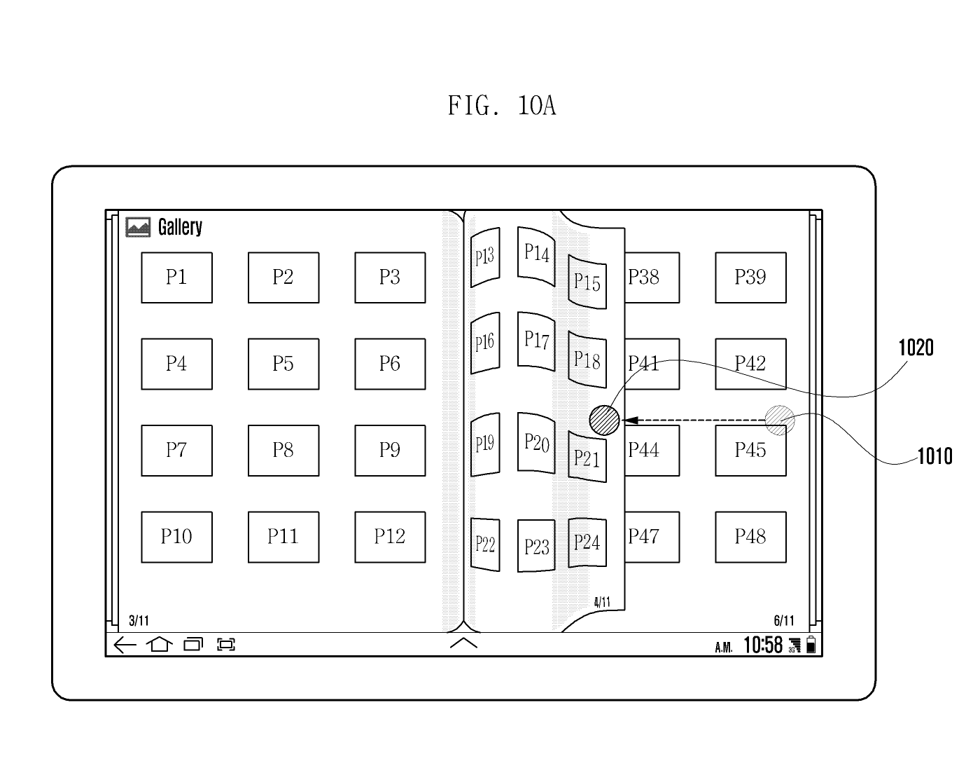

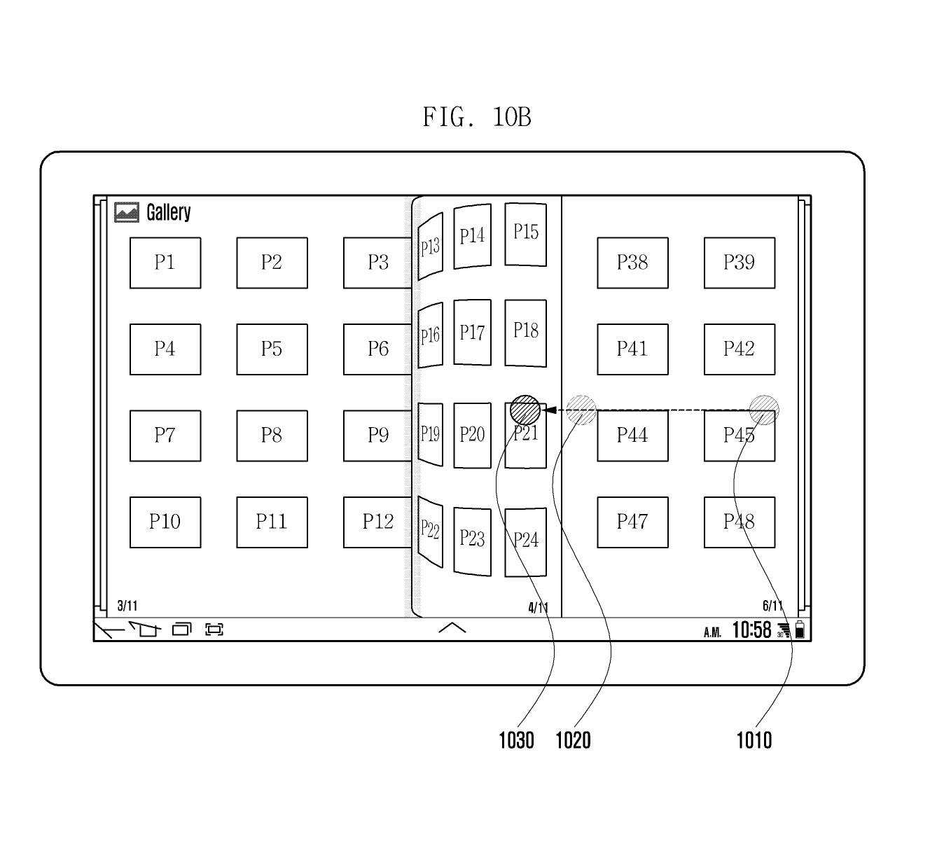

Referring to FIGS. 10A and 10B, the user touches the touch input device at a right side point 1010 of a center of the page (e.g., page 4/11), and moves the touch input device to an opposite side (left side). That is, FIG. 10A illustrates an animation where the touch input device is moved from the right side point 1010 to a left side and is located at a central point 1020. As shown in FIG. 10A, when the user moves the touch input device to a left side after the user touches a right side point 1010 of a center of the page, upper and lower portions of the page may be symmetrically and uniformly deformed. As shown in FIG. 10B, the user moves the touch input device from the central point 1020 in a leftward direction to a right side point 1030. That is, FIG. 10B illustrates an animation where the touch input device is located at the right side point 1030. As shown by a comparison of FIG. 10B with FIG. 10A, the page shown in FIG. 10B is more convex than the page shown in FIG. 10B. Accordingly, when the user releases the touch, the page of FIG. 10A is not skipped, but the page of FIG. 10B may be skipped. As shown by a comparison of FIG. 10A with FIG. 8A, moving directions of touch input devices in FIGS. 8A and 10A are the same (towards a left side), but initial touch coordinates thereof are different from each other. Accordingly, shapes of deformed pages are different from each other. As shown by a comparison of FIG. 10B with FIG. 8B, if the user releases a touch, a page of FIG. 8B is not skipped but a page of FIG. 10B may be skipped. Touches of FIGS. 8B and 10B start from a right side of the page. However, a touch of FIG. 10B starts from the center, and a touch of FIG. 8B starts from a lower portion of the center. Accordingly, in a case shown in FIG. 10B, upper and lower portions of the page may have a mass center towards a left side. As a result, the page is skipped. In contrast, in a case shown in FIG. 8B, a lower portion of the page has a mass center toward a left side but an upper portion of the page may have a mass center toward a right side. In this case, if the overall mass center of the page is toward a right side, the page may not be skipped. As a result, a direction of the mass center in the page may be associated with an initial touch coordinate as well as a current touch coordinate and a moving direction of the touch input device.

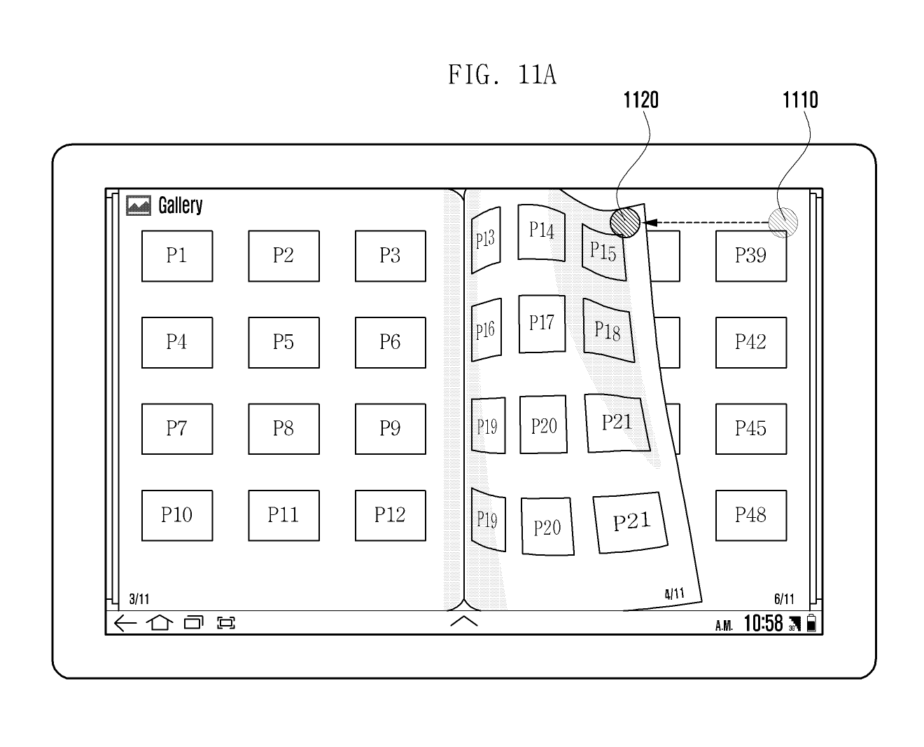

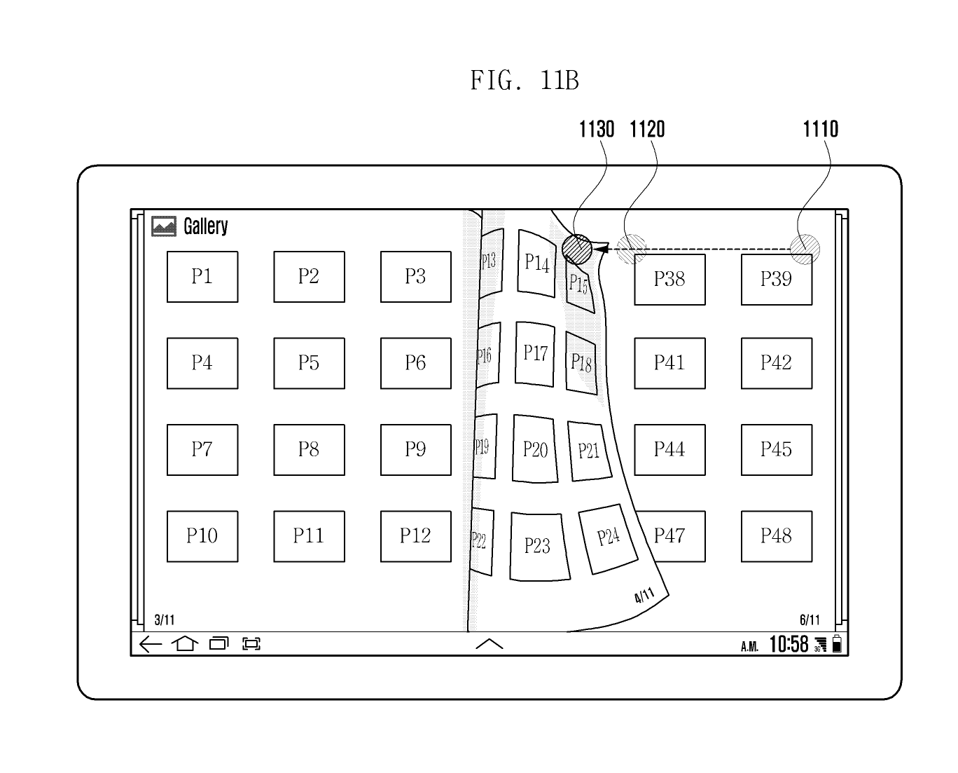

Referring to FIGS. 11A and 11B, the user touches a touch input device at a right top peripheral point 1110 of a page (e.g., page 4/11), and moves the touch input device from the point towards a point in the top periphery. That is, FIG. 11A illustrates an animation where the touch input device is moved from the right top peripheral point 1110 towards a left top periphery point and is located at a first top side point 1120. As shown in FIG. 11B, the user moves the touch input device from the first top side point 1120 along a top periphery in a left direction. That is, FIG. 11B is an animation where the touch input device is located at a second top side point 1130.

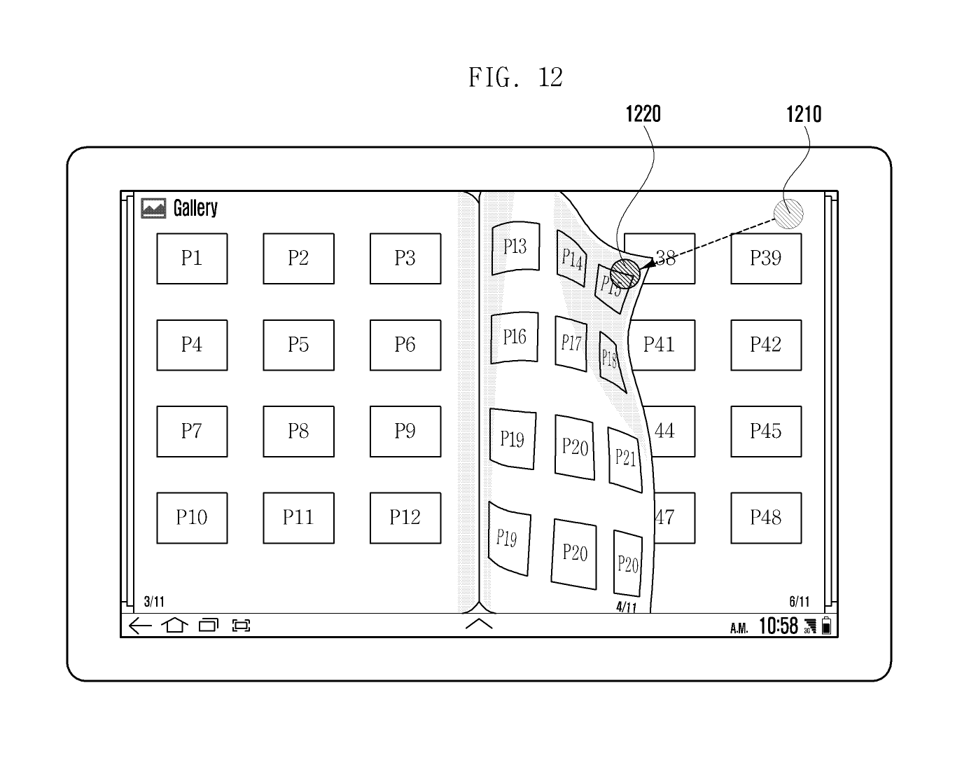

Referring to FIG. 12, the user touches the touch input device at a right top peripheral point 1210 of a page (e.g., page 4/11), and moves the touch input device from the right top peripheral point 1210 towards a left bottom periphery. That is, FIG. 12 illustrates an animation where the touch input device is moved from a right top peripheral point 1210 towards a left bottom periphery and is located at a top side point 1220. As shown by a comparison of FIG. 12 with FIG. 11A, touch input devices in FIGS. 11A and 12 start from a right top peripheral point but moving directions thereof are different from each other. Accordingly, shapes of deformed pages are different from each other.

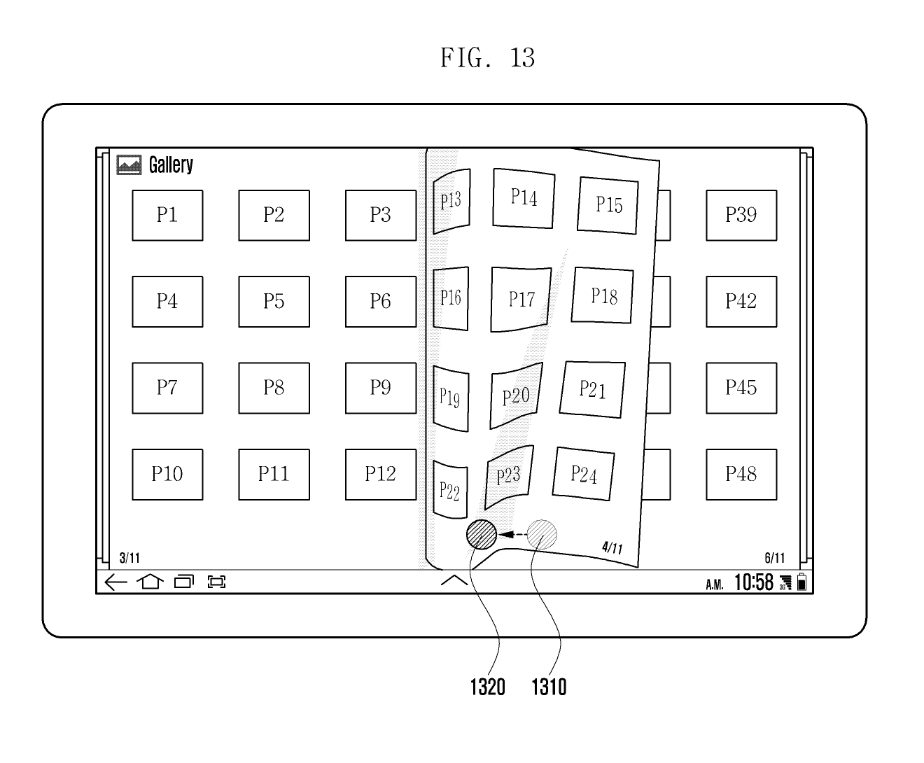

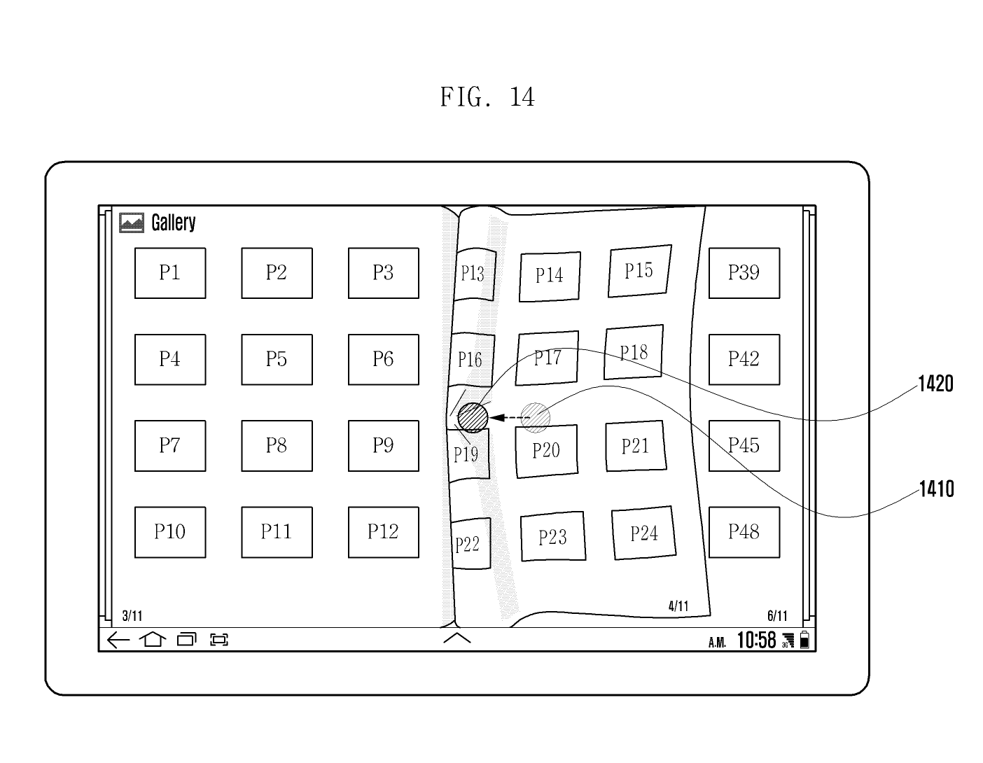

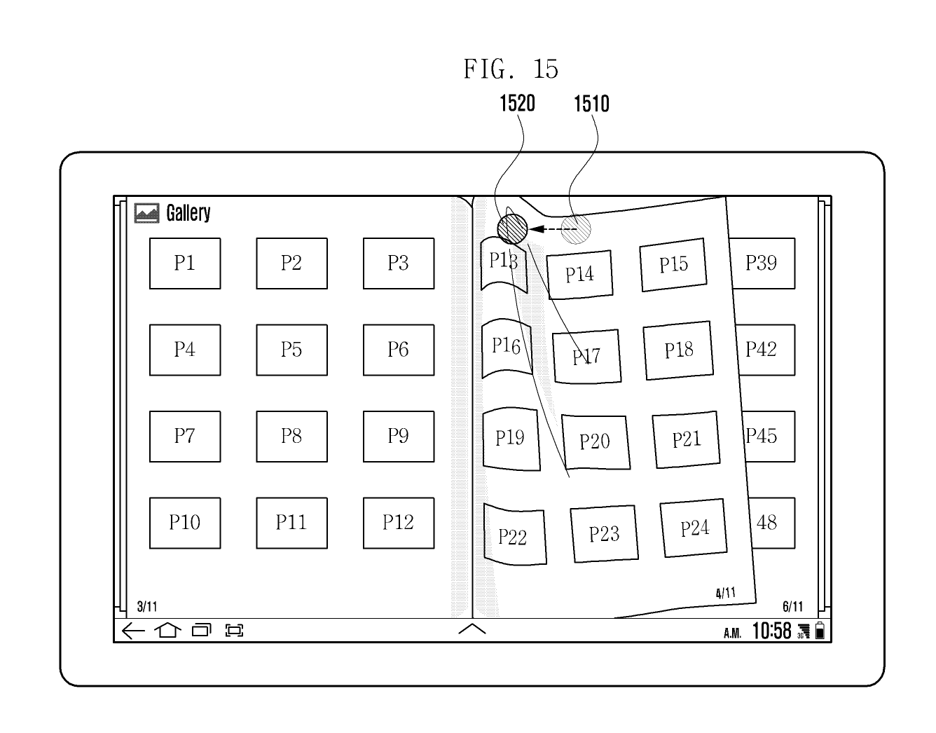

Next, FIG. 13 illustrates an animation where the touch input device is moved from a first left bottom peripheral point 1310 of the page (e.g., page 4/11) to a left side and is located at a second left bottom peripheral point 1320. FIG. 14 illustrates an animation where the touch input device is moved from the first left side point 1410 to the left side and is located at a second left side point 1420. FIG. 15 illustrates an animation where the touch input device is moved from the first left top peripheral point 1510 and is located at the second left top peripheral point 1520.

The user may touch all parts of the page as well as touch coordinates described in FIGS. 8 to 15. Accordingly, it is understood that deformation of the page may be changed according to a touch coordinate, a moving direction, and speed.

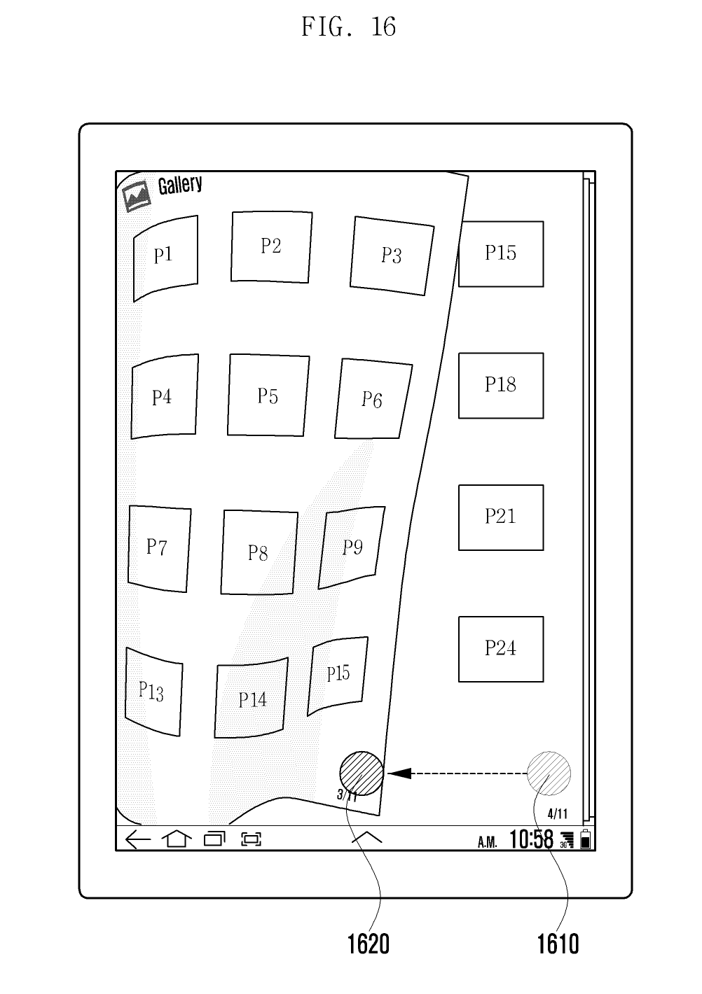

Referring to FIG. 16, a display mode is set to a portrait mode. The display unit 110 may display one page in the portrait mode. A user touches the touch input device at a right bottom peripheral point 1610 of a page (e.g., page 4/11). Then, the controller 160 detects a target node corresponding to the right bottom peripheral point 1610. The user moves the touch input device towards a left bottom periphery in a state in which the right bottom peripheral point 1610 is touched. Then, the controller 160 moves the target node towards the left bottom periphery. Further, the controller 160 calculates displacement of the moved target node. In detail, the controller 160 calculates a current location, moving speed, and a moving direction of the target node. The controller 160 calculates forces applied to respective nodes using the calculated displacement of the target node. The controller 160 calculates location values of the respective nodes using the calculated forces. The controller 160 generates an animator using the calculated location values of the nodes. The controller 160 controls the display unit 110 to display the generated animation. As described above, FIG. 16 illustrates an animation in which the touch input device is moved from the right bottom peripheral point 1610 towards a left bottom periphery and is located at a bottom side point 1620. If the touch input device approaches a left side within a preset threshold value (e.g., 10 mm from a left side of a screen), the controller 160 skips the page and controls the display unit 110 to display a next page (e.g., page 4/11).

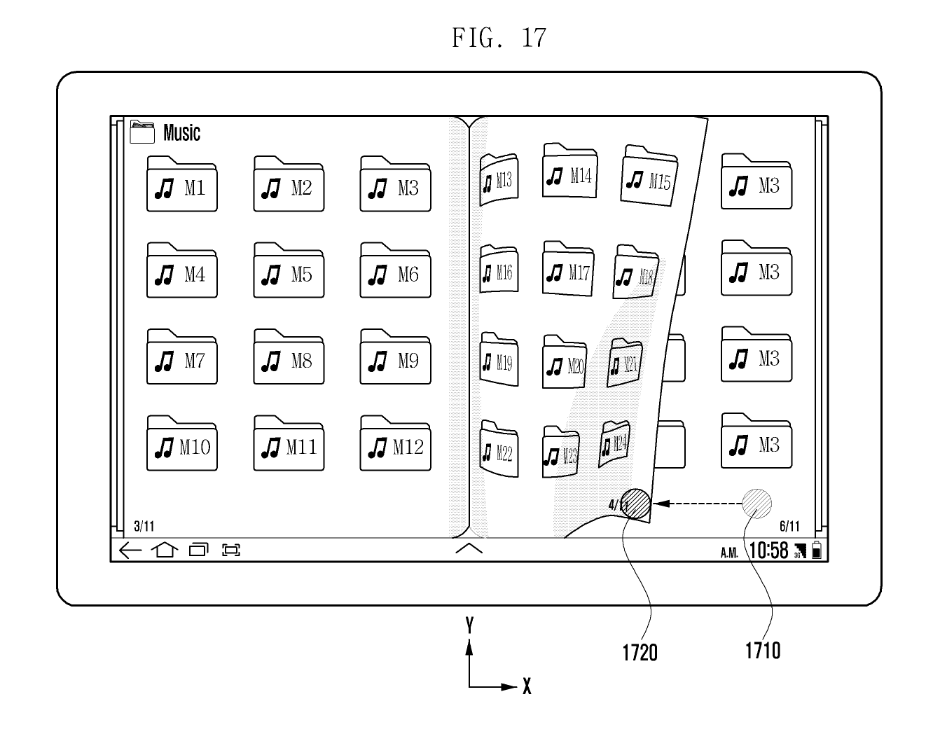

FIG. 17 illustrates a screen displaying a page of a music player, the number of pages of the music player being changeable. For example, one page includes a plurality of icons (e.g., 12 icons as illustrated in FIG. 17). The number of icons displayed per page may be changed by the user. Referring to FIG. 17, the user touches a touch input device at a right bottom peripheral point 1710 of a right page (e.g., page 4/11), and moves the touch input device from the right bottom peripheral point 1710 towards a left bottom periphery. Then, the controller 160 generates an animation and controls the display unit 110 to display the generated animation. FIG. 17 illustrates an animation (that is, a shape in which a page of a music player is convexly deformed) in which the touch input device is moved from the right bottom peripheral point 1710 towards a left periphery and is located at a bottom side point 1720. One page includes a plurality of icons (e.g., 12 icons). The icons may be displayed in many different ways, e.g., a list form, and are not limited to being displayed in a grid form as illustrated in FIG. 17. When the user taps the icon, corresponding music is played. According to exemplary embodiments, the page may include a music folder, a thumbnail or a music playback image. If the user taps the music folder, a corresponding music playback image is displayed. The music playback image includes an album cover photograph, a playback button, and a pause button. If the user taps the playback button, music included in the corresponding music folder may be sequentially or randomly played.

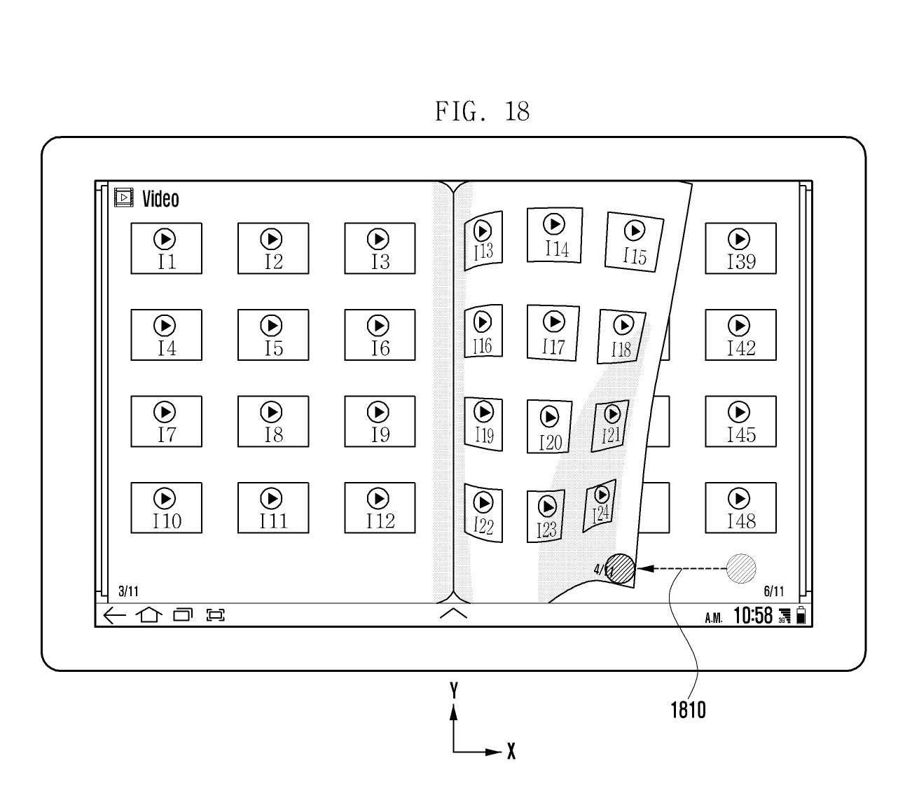

FIG. 18 illustrates a screen which displays a page of a video player, the number of pages of the video player being changeable. Referring to FIG. 18, in response to movement 1810 of the touch input device, a page of a video player is convexly deformed from the touched page (e.g., page 4/11). The page of the video player includes a plurality of icons (e.g., 12 icons). The number of icons displayed per page may be changed by the user. If the user taps one of the icons, a corresponding video is played. According to exemplary embodiments, the music player and the video player may be integrated with each other. That is, the music icon and the video icon may be displayed on one page. In the case of an integral type configuration, the page may also be convexly deformed.

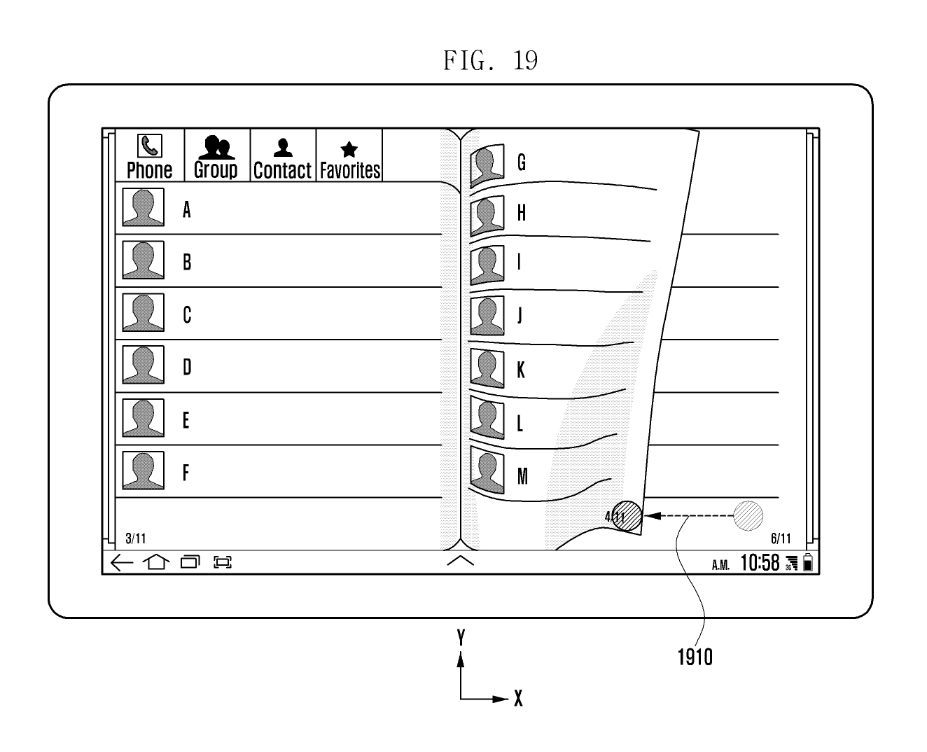

FIG. 19 illustrates a screen displaying a page of an address book, the number of pages of the address book being changeable. Referring to FIG. 19, in response to movement 1910 of the touch input device, a page of the address book is convexly deformed from the touched page (e.g., page 4/11). The page of the address book includes a plurality of contact point information. As shown in FIG. 19, the contact point information may be displayed in a form of a list, although is not limited thereto. The contact point information may also be displayed in another form, for example, in a form of a grid. If the user taps contact point information, corresponding detailed information (e.g., phone numbers, e-mail addresses, home addresses, office addresses) is displayed. According to an exemplary embodiment, the page of the address book may also be displayed in a portrait mode as illustrated in FIG. 16, rather than the landscape mode.

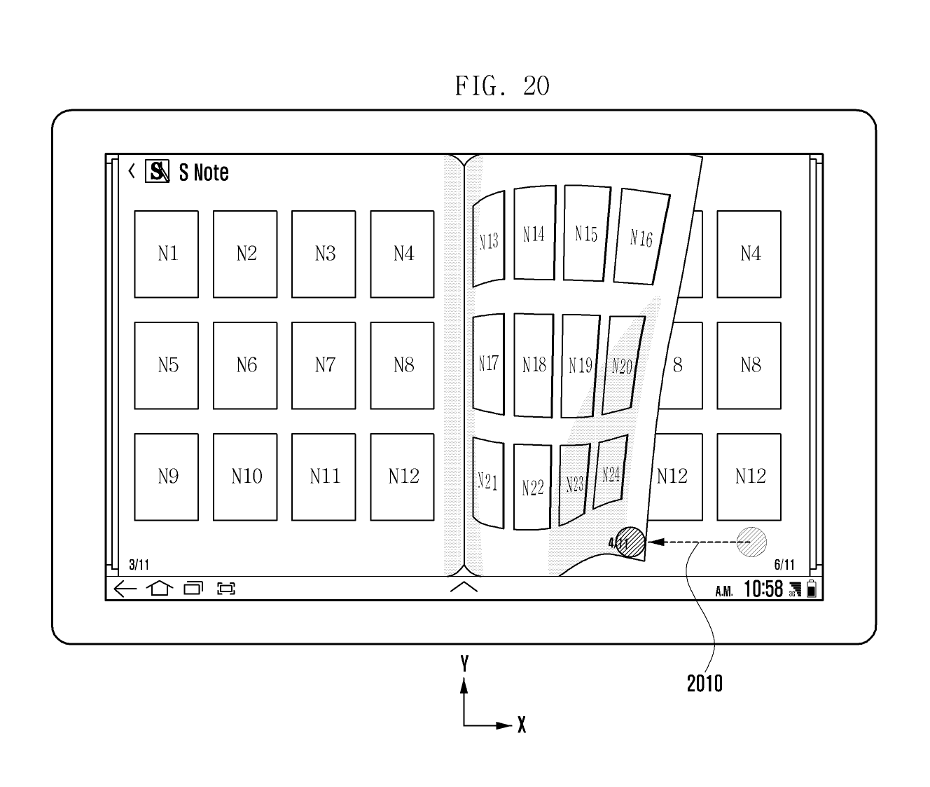

FIG. 20 illustrates a screen displaying a page of a memo note, the number of pages of the memo note being changeable. Referring to FIG. 20, in response to movement 2010 of the touch input device, a page of the memo address is convexly deformed from the touched page (e.g., page 4/11).

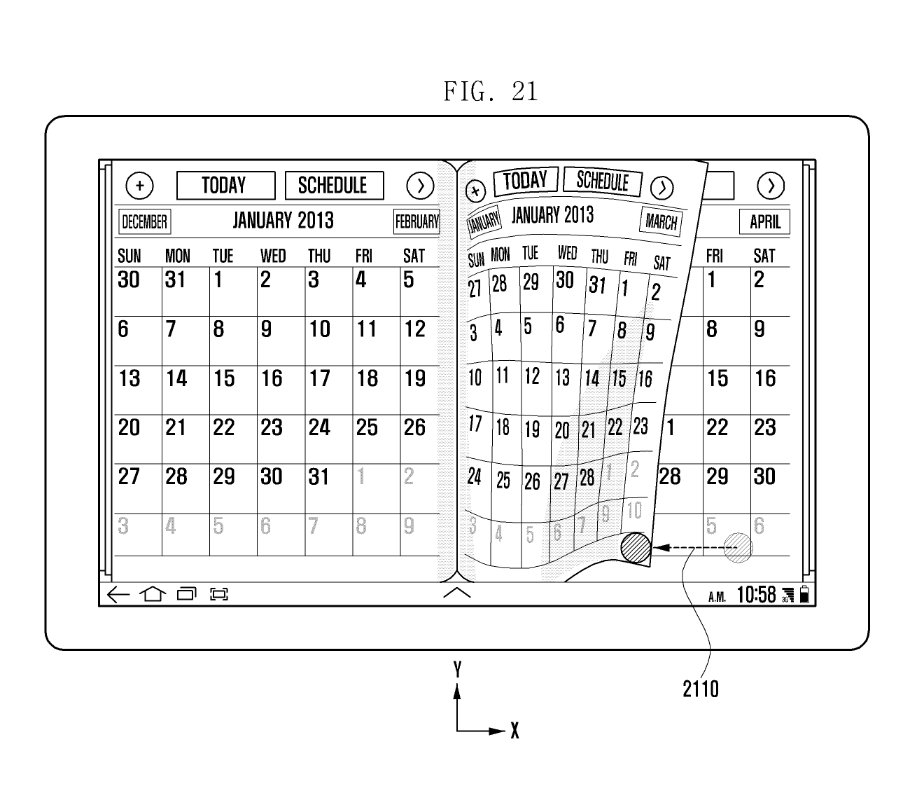

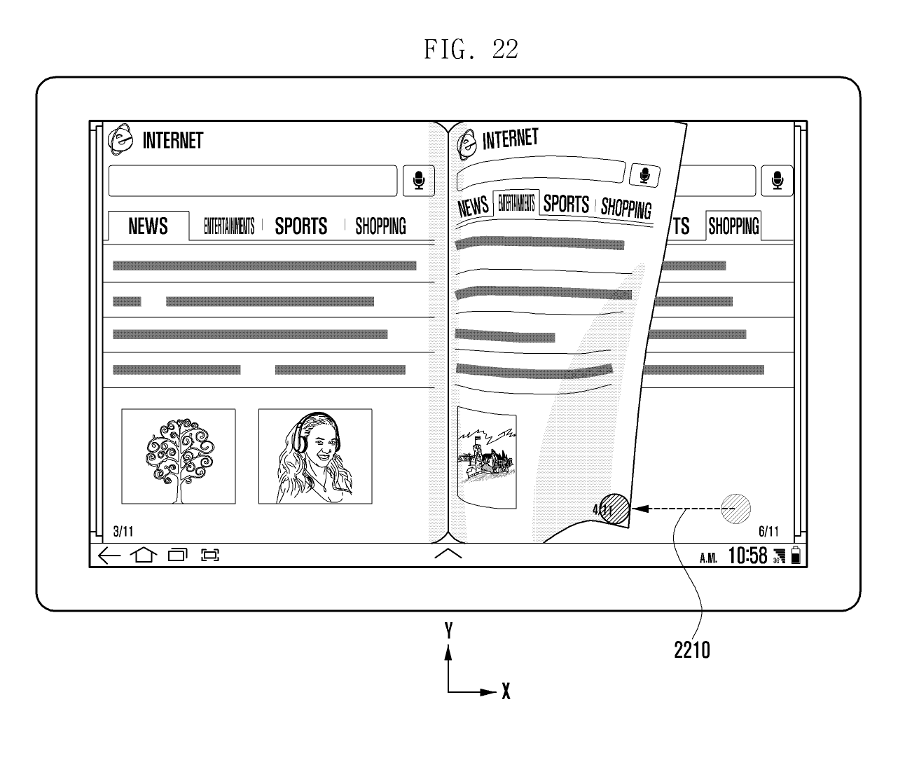

FIG. 21 illustrates a screen displaying a page of a calendar, the number of pages of the calendar being fixed. Referring to FIG. 21, in response to movement 2110 of the touch input device, a page (e.g., February 2012) of the calendar is convexly deformed from the touched page (e.g., page 4/11). FIG. 22 illustrates a screen displaying a page of a web browser, the number of pages of the web browser being fixed. Referring to FIG. 22, in response to movement 2210 of the touch input device, the page of the web browser is convexly deformed from the touched page (e.g., page 4/11).

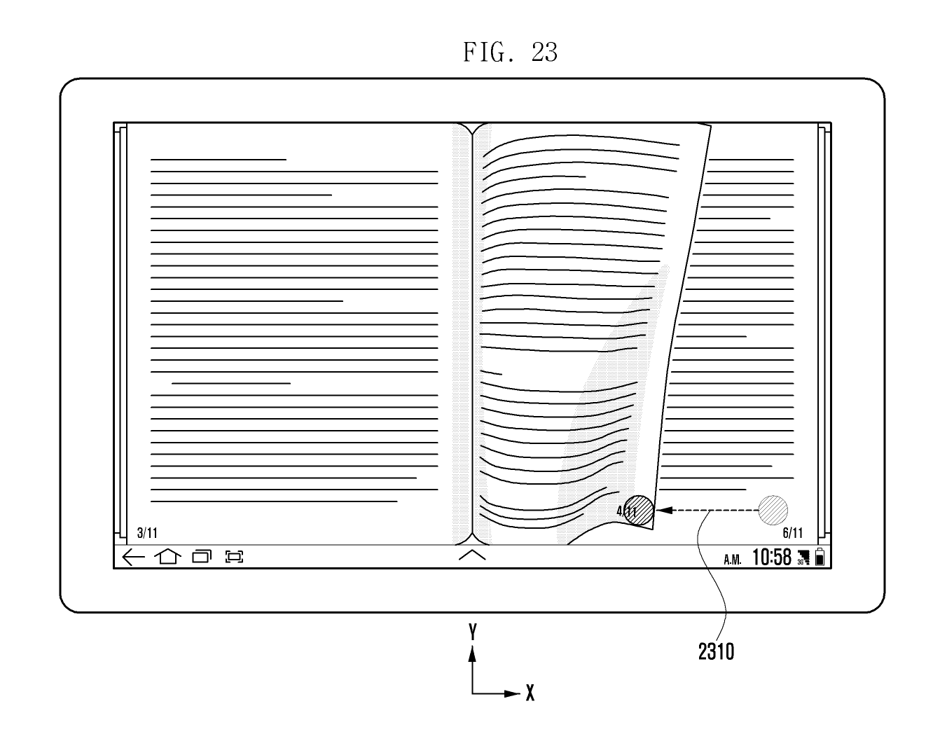

FIG. 23 illustrates a screen displaying a page of an electronic book, the number of pages of the electronic book being fixed. Referring to FIG. 23, in response to movement 2310 of the touch input device, the page of the electronic book is convexly deformed from the touched page (e.g., page 4/11).

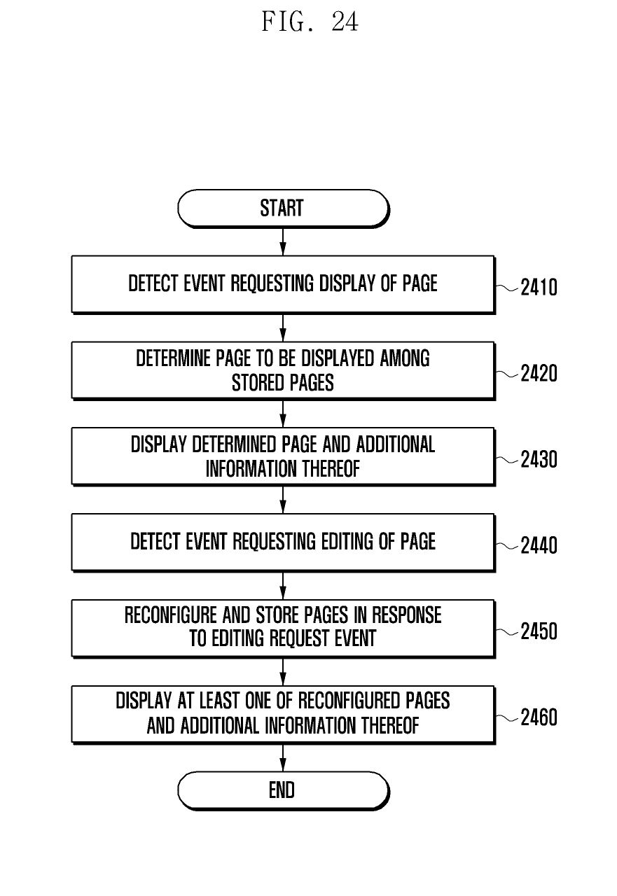

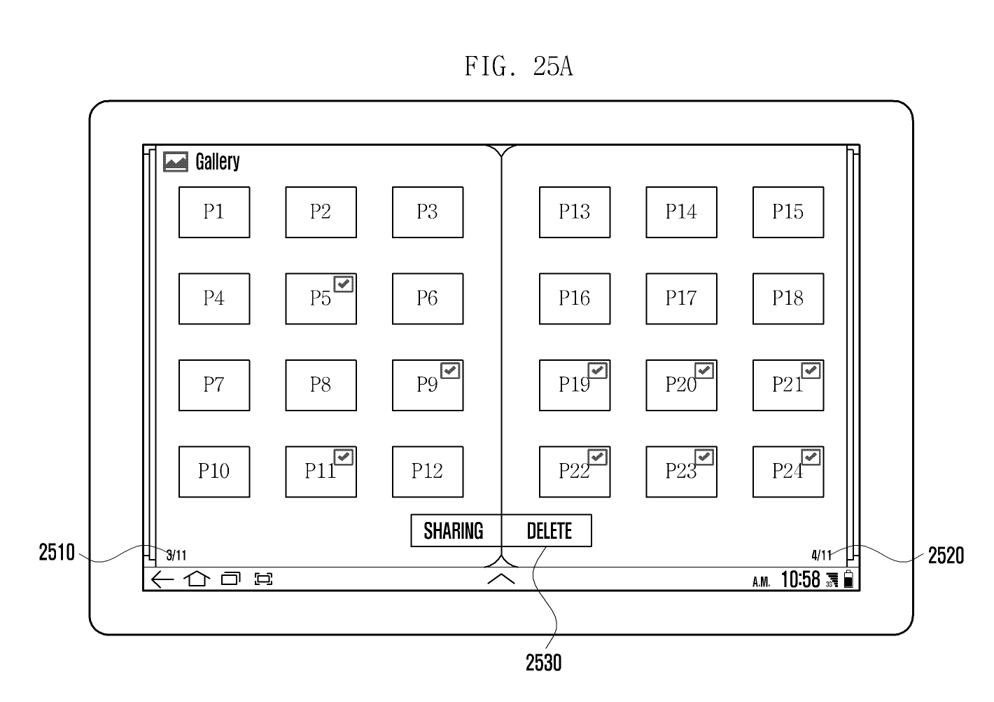

FIG. 24 is a flowchart illustrating a page editing method according to an exemplary embodiment.

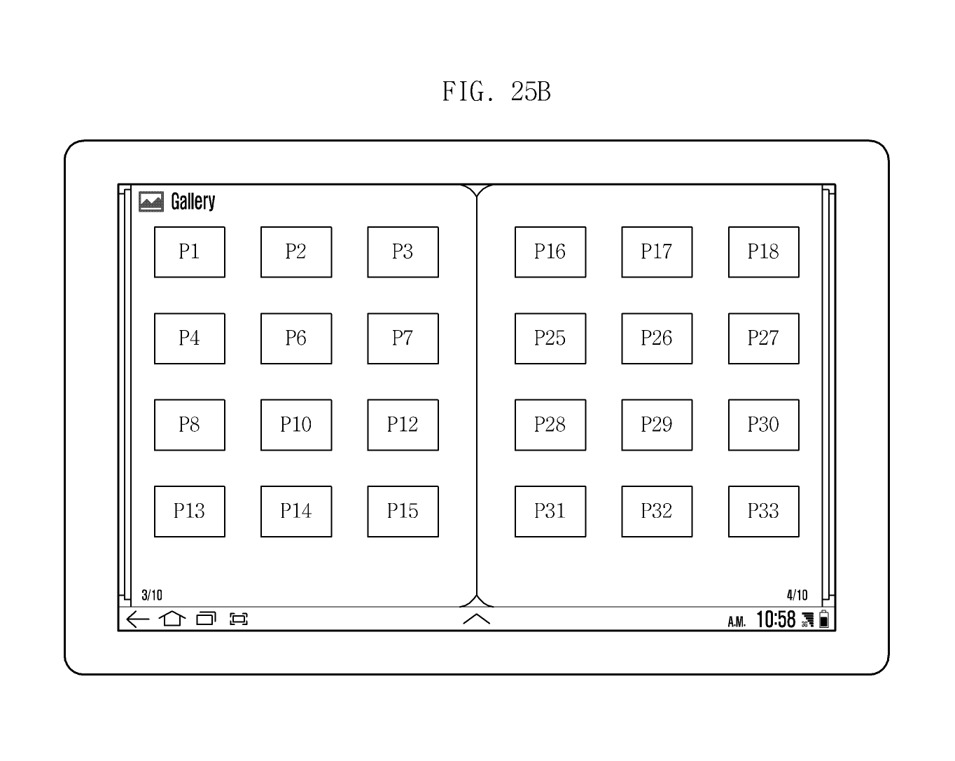

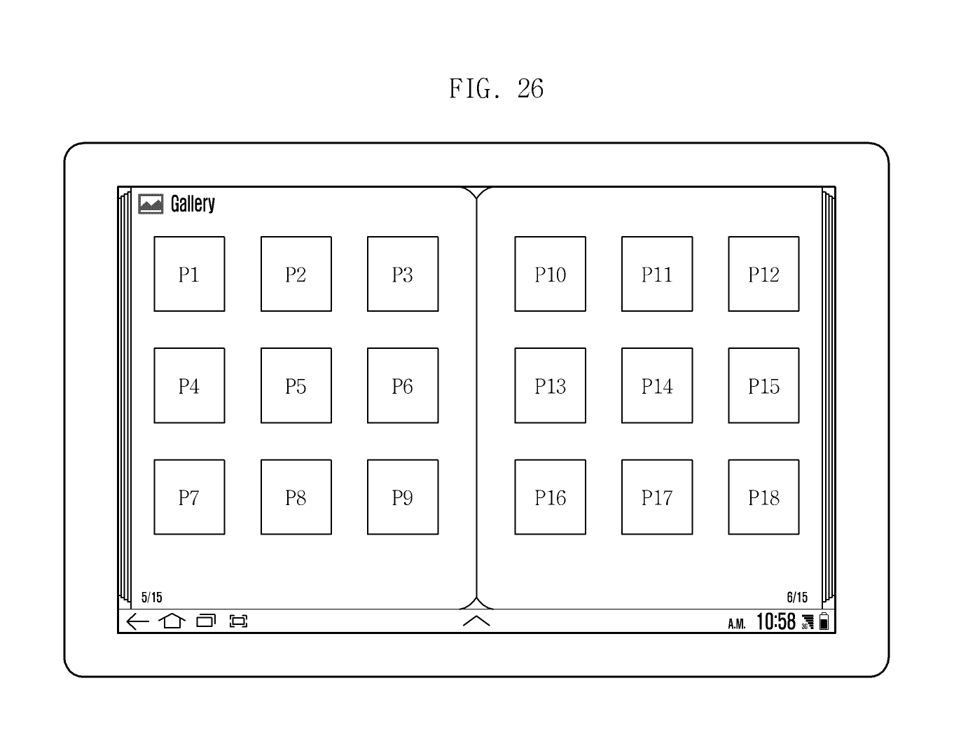

FIGS. 25A to 26 are diagrams of screens illustrating a page editing method according to an exemplary embodiment.

Referring to FIG. 24, a controller 160 detects an event requesting the display of a page (operation 2410). For example, the request event is a tap of a touch input device with respect to an application icon. If the request event is detected, the controller 160 determines a page to be displayed among stored pages of a corresponding application (operation 2420). For example, the controller 160 may display the most recently displayed page before a corresponding application was terminated as the page to be displayed. The controller 160 controls the display unit 110 to display the determined page and additional information thereof (operation 2430). For example, referring to FIG. 25A, the additional information includes a number 2510 of a corresponding page and the number 2520 of a total number of pages. The controller 160 detects an event requesting editing of the page (operation 2440). For example, referring to FIG. 25A, the request event is a tap of the touch input device on a delete button 2530. The controller 160 reconfigures pages in response to the editing request event and stores the reconfigured pages in a secondary memory 130 (operation 2450). Further, the controller 160 controls the display unit 110 to display at least one of the reconfigured pages and additional information thereof (operation 2460). For example, referring to FIGS. 25A and 25B, the controller 160 reconfigures pages using the remaining pages except for pages P 5, P 9, P 11, and P 19˜P 24 selected by the user from a contents list in response to a tap of the delete button 2530. Accordingly, the total number of the pages is changed from 11 to 10. Further, in the examples shown in FIGS. 25A and 25B, the order of the currently display pages may be maintained, but it is understood that the order of currently displayed pages may be changed. According to exemplary embodiments, contents such as videos, audio, images, contact points, memos, documents, thumbnails, and icons as well as photographs may be edited (e.g., deleting contents from the page, adding contents to the page, or moving the contents to another page).

According to exemplary embodiments, the pages may be configured in the order of time. For example, when a shooting time of a first photograph is earlier than that of a second photograph, the first photograph is configured at a previous page as compared with the second photograph. Further, the pages may be configured by places. For example, a first page is configured by photographs shot in Seoul, and a second page is configured by photographs in New York. If an arrangement scheme of contents is changed from “time” to “place” or vice versa by the user, the controller 160 may reconfigure pages, and accordingly, at least one of an order of currently displayed pages and a total number of pages may be changed.

If a format of the page is changed, the controller 160 reconfigures the pages, and accordingly, at least one of an order of currently displayed pages and a total number of pages may be changed. In detail, the number of contents included in one page may be changed. For example, each of the pages shown in FIGS. 25A and 25B respectively includes 12 contents, and the page of FIG. 26 includes 9 contents. Accordingly, information (e.g., a number) indicating the order of currently displayed pages is changed and the changed information is displayed, and information indicating the total number of pages is changed and the changed information is displayed. Further, an arrangement scheme of contents in the page may be changed. That is, the contents may be arranged in a form of a grid, a list, or some other form. In this manner, if the arrangement scheme is changed, the number of contents included in the page may be changed. Also, the information indicating an order of currently displayed pages may be changed and the changed information may be displayed. In addition, information indicating the total number of pages may be changed and the changed information may be displayed.

The foregoing method for displaying contents according to exemplary embodiments may be implemented in an executable program command form by various computer components and may be recorded in a computer readable recording medium. According to exemplary embodiments, the computer readable recording medium may include a program command, a data file, and a data structure individually or a combination thereof. According to exemplary embodiments, the program command recorded in a recording medium may be specially designed or configured for the exemplary embodiments or be known to a person having ordinary skill in a computer software field to be used. The computer readable recording medium may include magnetic media such as a hard disk, floppy disk, or magnetic tape, optical media such as a Compact Disc Read Only Memory (CD-ROM) or Digital Versatile Disc (DVD), magneto-optical media such as a floptical disk, and a hardware device such as ROM, RAM, and flash memory storing and executing program commands. Further, the program command may include a machine language code created by a complier and a high-level language code executable by a computer using an interpreter. The foregoing hardware device may be configured to be operated as at least one software module to perform an operation according to the exemplary embodiments.

As mentioned above, according to the contents display method and the mobile terminal of the exemplary embodiments, the exemplary embodiments provide a highly realistic feeling to a user when the user operates a screen on which pages are displayed.

Although exemplary embodiments have been described in detail hereinabove, it should be clearly understood that many variations and modifications of the basic inventive concepts disclosed herein which may appear to those skilled in the present art will still fall within the spirit and scope of the exemplary embodiments, as defined in the appended claims.

What is claimed is:

1. A method of displaying contents of pages displayed by a mobile terminal including a display unit in which a touch panel is installed, the method comprising:
displaying a page;
detecting movement of a touch input device with respect to the displayed page; and
displaying the page so that the page is convexly deformed and skipped in response to the movement of the touch input device.

2. The method of claim 1, further comprising:
detecting an editing request event requesting editing of the contents;
reconfiguring the page in response to the editing request event; and
displaying the reconfigured page and additional information of the reconfigured page.

3. The method of claim 2, wherein the additional information comprises information indicating a total number of pages and an order of the displayed pages.

4. The method of claim 2, wherein the editing request event comprises one of an addition request to add contents to the contents, a delete request to delete contents from the contents, a movement request to move the contents, and a change request to change a formation of the page.

5. The method of claim 4, wherein the reconfiguring of the page comprises changing at least one of a total number of the pages and an order of the displayed pages.

6. The method of claim 1, wherein the contents comprises at least one of photographs, videos, audio, images, calendars, contact points, memos, documents, e-books, web pages, thumbnails, and icons.

7. The method of claim 1, wherein the displaying of the page so that the page is convexly deformed and skipped comprises displaying a convexly deformed page corresponding to attribute information set for the page.

8. The method of claim 1, wherein the detecting of the movement of the touch input device comprises detecting at least one of a moving direction, a moving distance, and a speed of the touch input device.

9. The method of claim 1, wherein the displaying of the page so that the page is convexly deformed and skipped comprises deforming a plurality of the pages into convex forms which are different from each other and displaying the deformed pages.

10. The method of claim 1, further comprising:
determining a direction of a force applied to the convexly deformed page based on at least one of an initial touch coordinate, a current touch coordinate, a moving distance, and a moving direction of the touch input device; and
displaying the convexly deformed page such that the convexly deformed page is moved according to the determined direction of the force when a touch release of the touch input device with respect to the convexly deformed page is detected.

11. The method of claim 1, further comprising displaying the convexly deformed page so that the convexly deformed page is moved according to a moving direction of the touch input device before a touch release of the touch input device with respect to the convexly deformed page is detected.

12. A mobile terminal comprising:
a display unit in which a touch panel is installed and configured to display contents for each of a plurality of pages;
a memory configured to store the contents of the pages; and
a controller configured to control the display unit such that one of the pages is displayed, detect movement of a touch input device with respect to the displayed page, and control the display unit such that the page is displayed as convexly deformed and skipped in response to the detected movement of the touch input device.

13. The mobile terminal of claim 12, wherein the controller is further configured to detect an editing request event requesting editing of the contents, reconfigure and store the page in response to the editing request event, and control the display unit such that the reconfigured page and additional information of the reconfigured page are displayed.

14. The mobile terminal of claim 13, wherein the additional information comprises information indicating a total number of the pages and an order of the pages.

15. The mobile terminal of claim 13, wherein the editing request event comprises one of an addition request to add contents to the contents, a delete request to delete contents from the contents, a movement request to move the contents, and a change request to change of a formation of the page.

16. The mobile terminal of claim 15, wherein the control unit reconfigures the page by changing of at least one of a total number of the pages and an order of the pages.

17. The mobile terminal of claim 12, wherein the memory is further configured to store attribute information of the page, and the controller is further configured to convexly deform the page corresponding to the attribute information.

18. The mobile terminal of claim 12, wherein the controller is further configured control the display unit to display the page such that the page is moved according to a moving direction of the touch input device before a touch release of the touch input device with respect to the page is detected.

19. A non-transitory computer readable recording medium implemented in a mobile terminal including a display unit in which a touch panel is installed, the non-transitory computer readable recording medium causing the mobile terminal to perform operations comprising:
displaying a page;
detecting movement of a touch input device with respect to the displayed page; and
displaying the page so that the page is convexly deformed and skipped in response to the movement of the touch input device.

20. A method to display pages, the method comprising:
displaying a page on a device comprising a touch input unit;
generating a page mesh corresponding to the displayed page, the page mesh comprising a plurality of nodes having respective weights;
detecting movement of a touch input device with respect to the displayed page, using the touch input unit; and
changing an appearance of the page according to the detected movement and the page mesh,
wherein the changing the appearance of the page comprises convexly deforming the page.
